(19) United States
(12) Patent Application Publication
(10) Pub. No.: US 2020/0209391 A1
(43) Pub. Date: Jul. 2, 2020

(54) AUTOMATIC VEHICULAR SENSOR ADJUSTMENT METHOD AND SYSTEM THEREOF

(71) Applicant: Industrial Technology Research Institute, Hsin-chu (TW)

(72) Inventors: CHIA-JUI HU, New Taipei City (TW); WEN-HAN LU, Chiayi County (TW); TSE-LIN LEE, New Taipei City (TW); YU-HSIANG HAO, Taoyuan City (TW); YU-SYUAN LIAO, Taoyuan City (TW)

(21) Appl. No.: 16/232,171

(22) Filed: Dec. 26, 2018

(51) Int. Cl. G01S 17/08; G06K 9/00; B60W 50/08

(52) U.S. Cl. CPC G01S 17/08; B60W 50/08; G06K 9/00791

(57) ABSTRACT

An automatic vehicular sensor adjustment method includes: a step of installing a vehicular sensor with a posture on a vehicle body, the posture being defined by at least one of a distance, an inclination and a facing angle of the vehicular sensor with respect to the vehicle body, the distance including a height and a position of the vehicular sensor with respect to the vehicle body; a step of, according to an environmental scenario in which the vehicle body encounters, determining whether or not there is an adjustment need, the environmental scenario including a single event or multiple events; and, a step of, according to the adjustment need, adjusting the posture of the vehicular sensor. In addition, an automatic vehicular sensor adjustment system is also provided.

### TECHNICAL FIELD

The present disclosure relates in general to an automatic vehicular sensor adjustment method and a system thereof.

### BACKGROUND

The self-driving car, or so-called the autonomous car, the computer-driving car or the wheeled mobile robot, is an automatic vehicle for transportation. As an automatic vehicle, environmental detection and navigation would be performed in a man-less manner In the art, one of major components for maneuvering the self-driving car/vehicle is the detector/sensor. Most of the detectors on the self-driving vehicle are stationary; i.e., positioned with constant heights and angles (including inclination and/or facing angles). Thereupon, detected regions of these fixed detectors are limited and fixed.

In order to relieve the detector from a limited detected region, multiple fixed detectors are usually arranged to different positions at the vehicle body, such that the problem in the original limited detected region of the single detector can be resolved. If a fixed detector to be mounted at a lower position of the vehicle body, though detection advantages can be obtained in a basement, a tunnel, a culvert or the like, yet the surrounding objects may be occluded because of limited detection range. On the other hand, in the case that the fixed detector is mounted higher at the vehicle body, though a broader sight view can be obtained, yet the applicability of the vehicle, in some environmental circumstances may be pretty concerned; such as the basement, the tunnel, the culvert or the like. Further, in some situations of change of terrain (for example, up/down hill, or winding roads), adjustment in positioning the fixed detector might be necessary.

As mentioned above, a vehicle on the road is inevitable to meet various environmental scenarios, such as environmental height limits, speed limits, road slopes, intersections, winding roads, obstacles or occluded detectors. All these versatile environmental scenarios would affect detected region of individual fixed detectors. In particular, the detected regions of some specific fixed detectors would be unable to cover or detect target objects within specific distance ranges. Even by varying the angling to adjust the detecting range of the fixed detector, and further by providing multiple fixed detectors to organize a broader detecting range, it is sometimes still difficult to satisfy all the practical needs, especially under a dynamic environment. Namely, to detect a target object within a specific distance range of detection under a dynamic environment is always a tough issue in the industry of autonomous vehicles.

### SUMMARY

The present disclosure provides an automatic vehicular sensor adjustment method and a system thereof, which can adjust in time a posture of a related vehicular sensor according to different adjustment needs for different environmental scenarios, so that the problem in the limited detection range caused by the conventional fixed detector can be resolved.

In this disclosure, one embodiment of the automatic vehicular sensor adjustment method includes: a step of installing a vehicular sensor with a posture on a vehicle body, the posture being defined by at least one of a distance, an inclination and a facing angle of the vehicular sensor with respect to the vehicle body, the distance including a height and a position of the vehicular sensor with respect to the vehicle body; a step of, according to an environmental scenario in which the vehicle body encounters, determining whether or not there is an adjustment need, the environmental scenario including a single event or multiple events; and, a step of, according to the adjustment need, adjusting the posture of the vehicular sensor.

In this disclosure, an embodiment of the automatic vehicular sensor adjustment system, applicable to a vehicle body, includes a vehicular sensor, a control unit and a posture-adjusting mechanism The vehicular sensor has a posture. The posture is defined by at least one of a distance, an inclination and a facing angle of the vehicular sensor with respect to the vehicle body, in which the distance includes a height and a position of the vehicular sensor with respect to the vehicle body. The control unit, connected with the vehicular sensor, evaluates an environmental scenario to determine whether or not there is an adjustment need, determines an automatic vehicular sensor adjustment method according to the adjustment need, and outputs control signals. The environmental scenario includes a single event or multiple events. The posture-adjusting mechanism, connected with the vehicular sensor and the control unit, adjusts the posture of the vehicular sensor according to the control signals of the control unit.

As stated, in the automatic vehicular sensor adjustment method and the system thereof provided by this disclosure, according to different adjustment needs for different environmental scenarios, the posture of the vehicular sensor can be properly adjusted to provide a preferred detection coverage upon target objects, and also the detected region can be prevented from being occluded by the vehicle body and/or obstacles.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 is a schematic view of an embodiment of the automatic vehicular sensor adjustment system in accordance with this disclosure;

FIG. 2 is a schematic view of an exemplary example showing the automatic vehicular sensor adjustment system being mounted at a vehicle body;

FIG. 3A is a schematic view of an embodiment of the posture-adjusting mechanism in accordance with this disclosure;

FIG. 3B is a schematic view of an exemplary example showing an adjustment of a height of the vehicular sensor with respect to the vehicle body by the posture-adjusting mechanism in accordance with this disclosure;

FIG. 3C is a schematic view of an exemplary example showing an adjustment of an inclination of the vehicular sensor with respect to the vehicle body by the posture-adjusting mechanism in accordance with this disclosure;

FIG. 4 is a flowchart of an embodiment of the automatic vehicular sensor adjustment method in accordance with this disclosure;

FIG. 5 lists schematically possible environmental scenarios that a vehicle body can meet on the road;

FIG. 6A through FIG. 6C are integrated to show schematically a flowchart of an embodiment of adjusting a height of a vehicular sensor according to the automatic vehicular sensor adjustment method of this disclosure;

FIG. 7A through FIG. 7C are integrated to show schematically a flowchart of an embodiment of adjusting an inclination of a vehicular sensor according to the automatic vehicular sensor adjustment method of this disclosure;

FIG. 8 is a schematic flowchart of an embodiment of adjusting a facing angle of a vehicle sensor according to the automatic vehicular sensor adjustment method of this disclosure;

FIG. 9A shows schematically an exemplary example that the environmental scenario for the vehicle body is an event of lateral adjustment;

FIG. 9B is a schematic view of an exemplary example showing an adjustment of a facing angle of the vehicular sensor of FIG. 9A with respect to the vehicle body in accordance with this disclosure;

FIG. 9C is a schematic view of an exemplary example showing an adjustment of a position of the vehicular sensor of FIG. 9A with respect to the vehicle body in accordance with this disclosure;

FIG. 10 is a schematic view of another embodiment of the automatic vehicular sensor adjustment system in accordance with this disclosure; and

FIG. 11 is a flowchart of an extended embodiment of the automatic vehicular sensor adjustment method of FIG. 4.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

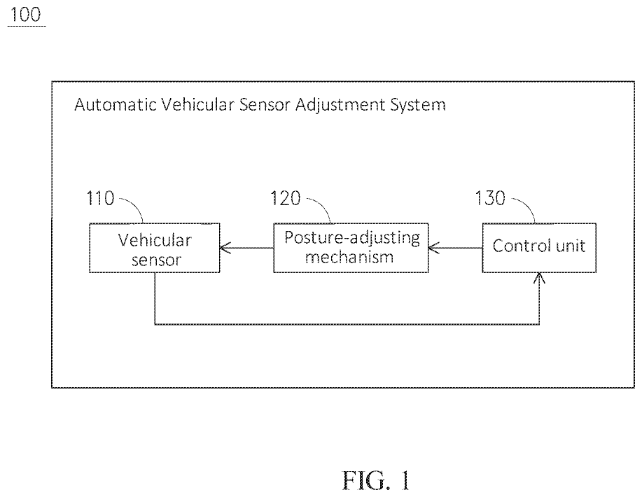

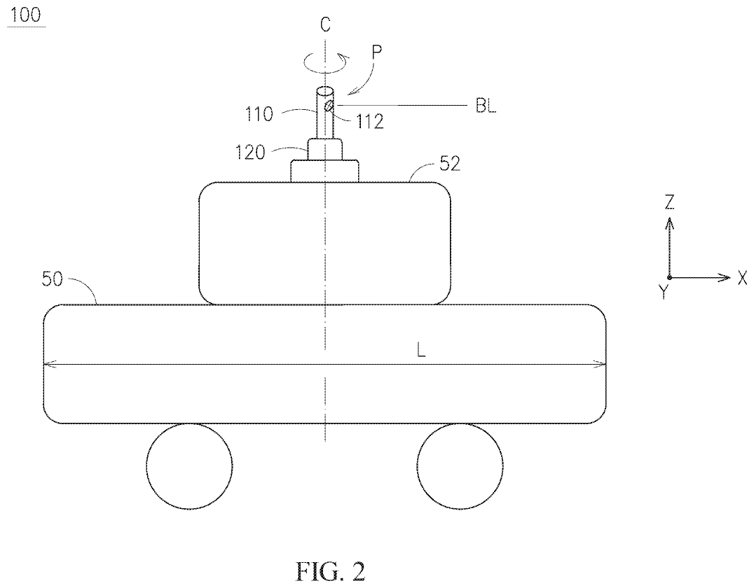

Refer now to FIG. 1 and FIG. 2; where FIG. 1 is a schematic view of an embodiment of the automatic vehicular sensor adjustment system in accordance with this disclosure, and FIG. 2 is a schematic view of an exemplary example showing the .automatic vehicular sensor adjustment system of FIG. 1 being mounted at a vehicle body. As shown, in this embodiment, the automatic vehicular sensor adjustment system 100 can be installed on a vehicle roof 52 of the vehicle body 50. In some other embodiments not shown here, the vehicular sensor 110 can be mounted to a lateral side or a relevant position of the vehicle body 50. The automatic vehicular sensor adjustment system 100 includes a vehicular sensor 110, a posture-adjusting mechanism 120 and a control unit 130, in which the posture-adjusting mechanism 120 is connected with the vehicular sensor 110 and a control unit 130, and the posture-adjusting mechanism 120 is located between the vehicular sensor 110 and the vehicle body 50. In this disclosure, the control unit 130 can include hardware (such as processors or mainframe computers), software (such as program commands performed by a processor), or a combination of hardware and software.

In this embodiment, the vehicular sensor 110, a LiDAR (Light detection and ranging) for example, includes a sensing portion 112. In the case that the vehicular sensor 110 is a LiDAR, a laser beam of the vehicular sensor 110 is projected onto the target object via passing through the sensing portion 112. By evaluating a time difference between a signal sending and the corresponding receiving, a distance from the target object can be obtained. The vehicular sensor 110 has a posture P defined by at least one of a distance, an inclination and a facing angle of the vehicular sensor 110 with respect to the vehicle body 50, in which the distance includes a height and a position of the vehicular sensor 110 respective to the vehicle body 50. In other words, the posture P of the vehicular sensor 110 is related to a detected region of the vehicular sensor 110.

It shall be explained that the term “height of the vehicular sensor 110 with respect to the vehicle body 50” stands for a mounting height of the vehicular sensor 110. That is, an adjustment of the height of the vehicular sensor 110 to the vehicle body 50 is equivalent to an adjustment of a vertical distance from the vehicular sensor 110 to the vehicle body 50. As shown in FIG. 2, the vehicular sensor 110 is mounted at a position on the vehicle roof 52, thus the mounting height of the vehicular sensor 110 is a sum of a height of the vehicle body 50 itself and a distance from a baseline BL of the vehicular sensor 110 to the vehicle roof 52, in which the height of the vehicle body 50 is a ground height of a highest point of the vehicle body 50 (the vehicle roof 42 in FIG. 2), and the baseline BL of the vehicular sensor 110 is a horizontal line passing the sensing portion 112 of the vehicular sensor 110. In one embodiment not shown here, the vehicular sensor 110 is furnished to one lateral side of the vehicle body 50, and then the mounting height of the vehicular sensor 110 is the difference between the height of the vehicle body 50 and the distance from the baseline BL of the vehicular sensor 110 to the vehicle roof 52.

It shall be explained that the term “position of the vehicular sensor 110 with respect to the vehicle body 50” stands for a mounting position of the vehicular sensor 110 at the vehicle body 50. That is, an adjustment of the position of the vehicular sensor 110 to the vehicle body 50 is equivalent to an adjustment of a horizontal distance from the vehicular sensor 110 to the vehicle body 50. As in FIG. 2, the vehicular sensor 110 is mounted on an X-Y plane at the vehicle roof 52. By moving linearly the vehicular sensor 110 forward, backward, leftward and/or rightward on the X-Y plane, the position of the vehicular sensor 110 on the vehicle roof 52 can be adjusted. In addition, the X-Y-Z orthogonal coordinate system used here is only one of many qualified coordinate systems, and not used to limit the scope of this disclosure.

It shall be explained that the term “inclination of the vehicular sensor 110 with respect to the vehicle body 50” stands for an angle formed by the baseline BL of the vehicular sensor 110 and a reference direction of the vehicle body 50. As shown in FIG. 2, the reference direction can be a longitudinal direction L of the vehicle body 50; i.e., the lengthwise direction extending along X axis from a head to a tail of the vehicle body 50. In addition, a centerline C of the vehicular sensor 110 parallel to the Z axis extends to pass through the longitudinal direction L of the vehicle body 50. The inclination of the vehicular sensor 110 is the angle on the Z-X plane formed by the baseline BL of the vehicular sensor 110 and the longitudinal direction L of the vehicle body 50, as shown in FIG. 2. For example, in FIG. 2, the inclination of the vehicular sensor 110 is 0 degree; i.e., the baseline BL being parallel to the longitudinal direction L of the vehicle body 50. In addition, the X-Y-Z orthogonal coordinate system used here is only one of many qualified coordinate systems, and not used to limit the scope of this disclosure.

It shall be explained that the term “facing angle of the vehicular sensor 110 with respect to the vehicle body 50” stands for an angle between the baseline BL of the vehicular sensor 110 and a reference direction of the vehicle body 50 formed by rotating the vehicular sensor 110 about the centerline C. As shown in FIG. 2, the reference direction is the longitudinal direction L of the vehicle body 50 on the X-Y plane, and the centerline C of the vehicular sensor 110 parallel to the Z axis is extended to pass through the longitudinal direction L of the vehicle body 50. The facing angle of the vehicular sensor 110 lies on the X-Y plane, and is formed with respect to the longitudinal direction L of the vehicle body 50 by rotating the baseline BL of the vehicular sensor 110 about the centerline C, as shown in FIG. 2. In addition, Generally speaking, as shown in FIG.2, in the case that the vehicular sensor 110 is a LiDAR, the sensing portion 112 can perform a 360-degree detection. In the following description upon the facing angle of the vehicular sensor 110 with respect to the vehicle body 50, the sensing portion 112 of the vehicular sensor 110, assumed not to perform a 360-degree detection, is to, by rotating the vehicular sensor 110 about the centerline C, aim at a target object, provide a directing direction, or to provide a reference direction while in mounting. In addition, the X-Y-Z orthogonal coordinate system used here is only one of many qualified coordinate systems, and not used to limit the scope of this disclosure.

In this embodiment, the posture-adjusting mechanism 120 connected with the vehicular sensor 110 is used to adjust the posture of the vehicular sensor 110. In this disclosure, the posture-adjusting mechanism 120 can be at least a linear adjustment mechanism, a rotational adjustment mechanism, or a combination of the aforesaid two mechanisms. For example, as shown in FIG. 2, the posture-adjusting mechanism 120 as a linear adjustment mechanism can be used to adjust the height of the vehicular sensor 110 with respect to the vehicle body 50; for example, adjusting along the Z axis. Also, the linear adjustment mechanism 120 can be used to adjust the position of the vehicular sensor 110 with respect to the vehicle body 50. For example, as shown in FIG. 2, through the linear adjustment mechanism 120, the vehicular sensor 110 can be moved linearly leftward or rightward along the Y axis, can be moved linearly back and forth along the X axis, or can be moved linearly in an oblique direction on the X-Y plane. In addition, the rotational adjustment mechanism can be used to adjust the inclination of the vehicular sensor 110 with respect to the vehicle body 50. For example, as shown in FIG.2, the vehicular sensor 110 can be moved on the Z-X plane. On the other hand, the rotational adjustment mechanism can be also used to adjust the facing angle of the vehicular sensor 110 with respect to the vehicle body 50. For example, as shown in FIG. 2, the vehicular sensor 110 can be moved on the X-Y plane. In this embodiment, the posture-adjusting mechanism 120 adopts a combination of the linear adjustment mechanism and the rotational adjustment mechanism to adjust the distance, the inclination and/or the facing angle of the vehicular sensor 110 with respect to the vehicle body 50. In addition, the X-Y-Z orthogonal coordinate system used here is only one of many qualified coordinate systems, and not used to limit the scope of this disclosure.

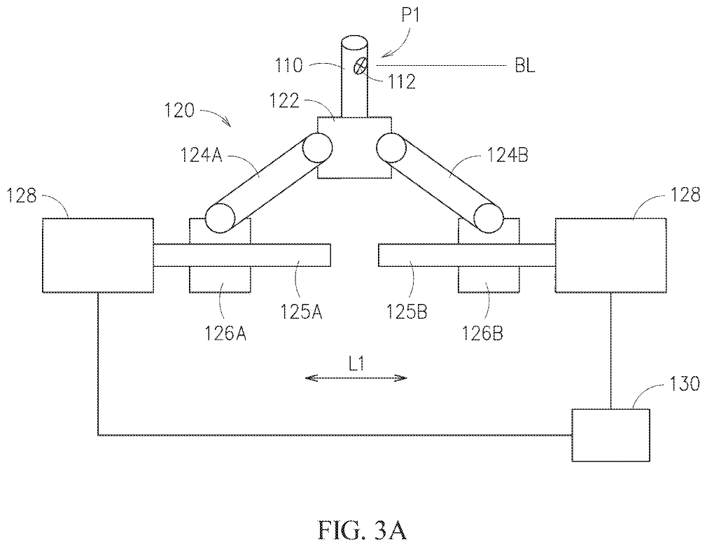

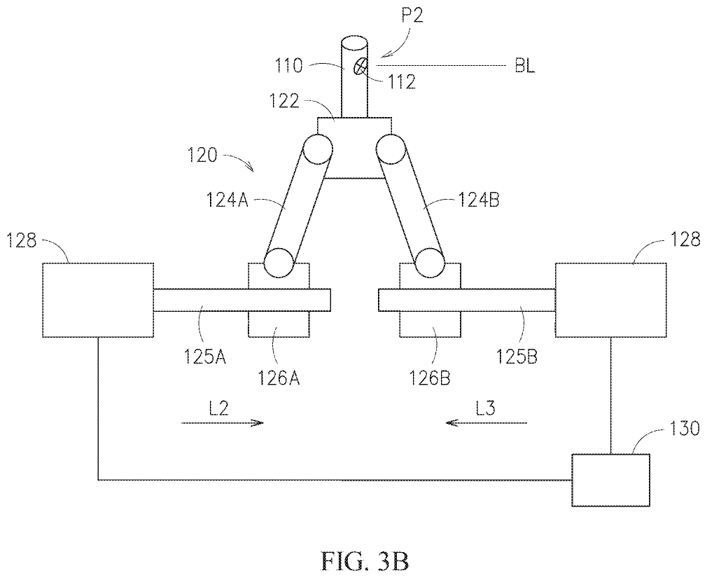

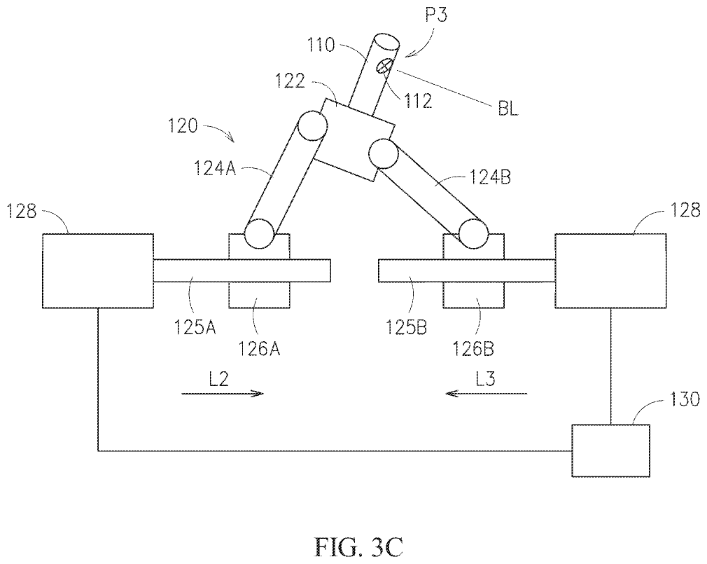

As shown in FIG. 3A through FIG. 3C, an embodiment of the posture-adjusting mechanism in accordance with this disclosure is shown in different states. Referring now to FIG. 3A, the posture-adjusting mechanism 120 includes a connection portion 122, a first linking member 124A, a second linking member 124B, a first transmission portion 125A, a second transmission portion 125B, a first motion portion 126A, a second motion portion 126B and two actuator units 128. The two actuator units 128 of the posture-adjusting mechanism 120 are individually connected with the control unit 130. The control unit 130 is used to output control signals to each of the actuator units 128, and then the actuator unit 128 evaluates the control signal so as to drive the respective members (such as the first transmission portion 125A and the second transmission portion 125B). In one embodiment not shown here, the control unit is built inside the actuator unit.

In this embodiment, a lower end of the vehicular sensor 110 is connected with the connection portion 122, and the vehicular sensor 110 has a posture P1. One end of the first linking member 124A and one end of the second linking member 124B are connected to two opposing ends of the connection portion 122, respectively. Another end of the first linking member 124A and another end of the second linking member 124B are connected to the first motion portion 126A and the second motion portion 126B, respectively. The first transmission portion 125A is used to transmit power to the first motion portion 126A so as to move the first motion portion 126A in a moving direction L1. The second transmission portion 125B is used to transmit power to the second motion portion 126B so as to move the second motion portion 126B in the moving direction L1. In this embodiment, the first transmission portion 125A and the second transmission portion 125B, separated from each other by a distance, are connected with respective actuator units 128. Namely, each of the actuator units 128 is to drive the corresponding first transmission portion 125A or the second transmission portion 125B. It shall be explained that the aforesaid term “moving direction L1” is parallel to the longitudinal direction L of the vehicle body 50 (referring to FIG. 2); i.e., the X axis of FIG. 2.

Referring to FIG. 3B, another state of FIG. 3A is shown, where the posture-adjusting mechanism adjusts the vehicular sensor to another height with respect to the vehicle body. In this embodiment, it is given that an adjustment need is to raise the height of the vehicular sensor 110 with respect to the vehicle body 50. The control unit 130 would account for the adjustment need to output corresponding control signals to the actuator units 128 of the posture-adjusting mechanism 120. The posture-adjusting mechanism 120 then evaluates the control signals from the control unit 130 to raise the height of the vehicular sensor 110 with respect to the vehicle body 50. In detail, one of the actuator units 128 rotates the first transmission portion 125A to linearly displace the first motion portion 126A in a first direction L2, while another actuator unit 128 rotates the second transmission portion 125B to linearly displace the second motion portion 126B in a second direction L3. In particular, a displacement stroke of the first motion portion 126A is equal to that of the second motion portion 126B, the first direction L2 is reverse to the second direction L3, and both the first direction L2 and the second direction L3 are parallel to the moving direction L1 of FIG. 3A. Thereupon, by having the first motion portion 126A and the second motion portion 126B to move oppositely, the first linking member 124A and the second linking member 124B can be operated synchronously to raise the connection portion 122 up and down. The vehicular sensor 110 connected with the connection portion 122 is thus moved as well to change its own height with respect to the vehicle body 50, from posture P1 of FIG. 3A to posture P2 of FIG. 3B. As shown, the baseline BL at posture P2 of FIG. 3B is higher than that at posture P1 of FIG. 3. Namely, by providing this embodiment, the posture-adjusting mechanism 120 can adjust the distance between the vehicular sensor 110 and the vehicle body 50. In addition, the actuator unit 128 can be a driving device such as a motor, and each of the first transmission portion 125A and the second transmission portion 125B can be a screw rod driven by the motor. In other words, the posture-adjusting mechanism 120 of this embodiment is consisted of a linear adjustment mechanism and a rotational adjustment mechanism, in which the screw rod transforms the kinematics from a rotational motion into a linear motion. However, this disclosure does not limit the embodiment of the posture-adjusting mechanism 120. In one embodiment not shown here, the posture-adjusting mechanism can be a combination of a worm and a worm gear, or a multi-bar linkage to adjust the height (i.e., the distance) of the vehicular sensor 110 with respect to the vehicle body 50.

Referring now to FIG. 3C, a further state of FIG. 3A is shown to demonstrate another exemplary example of the posture-adjusting mechanism, in which the inclination of the vehicular sensor with respect to the vehicle body is adjusted. It is given that the adjustment need is to reduce the inclination of the vehicular sensor 110 with respect to the vehicle body 50. Based on the adjustment need, the control unit 130 would issue corresponding control signals to the actuator units 128 of the posture-adjusting mechanism 120. Based on the control signals from the control unit 130, the posture-adjusting mechanism 120 would decrease the inclination of the vehicular sensor 110 with respect to the vehicle body 50. In detail, one actuator unit 128 would rotate the first transmission portion 125A to displace linearly the first motion portion 126A in the first direction L2, while another actuator unit 128 rotates the second transmission portion 125B to displace the second motion portion 126B in the second direction L3. In particular, the displacement stroke of the first motion portion 126A is different to that of the second motion portion 126B, the first direction L2 is reverse to the second direction L3, and both the first direction L2 and the second direction L3 are parallel to the moving direction L1 of FIG. 3A. Thereupon, the first motion portion 126A approaches the second motion portion 126B. Since the displacement strokes for the first motion portion 126A and the second motion portion 126B are not the same (in this embodiment, the displacement stroke of the first motion portion 126A is larger than that of the second motion portion 126B), the first linking member 124A and the second linking member 124B, connected to opposing sides of the connection portion 122, would generate a tilt thereto by raising the height of the connection portion 122 at the side having the first linking member 124A more than the height of the connection portion 122 at the opposite side having the second linking member 124B. Namely, the vehicular sensor 110 is thus tilted to another inclination shown by posture P3 of the vehicular sensor 110 in FIG. 3C; i.e., changing the inclination of the vehicular sensor 110 with respect to the vehicle body 50. As stated above, the posture-adjusting mechanism 120 of this disclosure can be, but not limited to, a combination of a linear adjustment mechanism and a rotational adjustment mechanism. In another embodiment not shown here, a multi-bar linkage can be used to replace the aforesaid rotational adjustment mechanism for adjusting the inclination of the vehicular sensor 110 with respect to the vehicle body 50.

Referring back to FIG. 1, the control unit 130 is connected with the vehicular sensor 110. According to an environmental scenario that the vehicle body encounters, the control unit 130 would determine whether or not there is an adjustment need, the control unit 130 would evaluate the adjustment need to perform an automatic vehicular sensor adjustment method for the posture-adjusting mechanism 120 to adjust the posture of the vehicular sensor 110, accordingly.

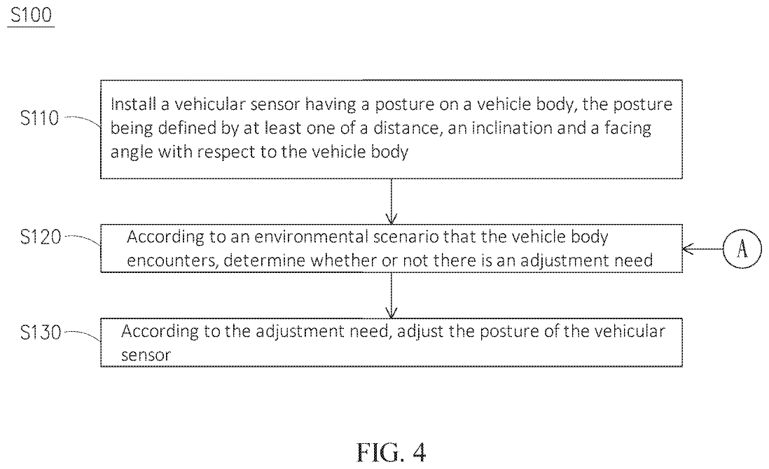

Referring now to FIG. 4, a flowchart of an embodiment of the automatic vehicular sensor adjustment method in accordance with this disclosure is shown.

This automatic vehicular sensor adjustment method S100 can be applied to the automatic vehicular sensor adjustment system 100 of FIG. 1 or FIG. 2, the automatic vehicular sensor adjustment method S100 includes Step S110 to Step S130 as follows. Firstly, in performing Step S110, a vehicular sensor 110 having a posture is mounted onto a vehicle body 50 (as shown in FIG. 2), and the posture is defined by at least one of a distance, an inclination and a facing angle of the vehicular sensor 110 with respect to the vehicle body. In particular, the distance of the vehicular sensor 110 with respect to the vehicle body 50 includes a height and a position of the vehicular sensor 110 with respect to the vehicle body 50.

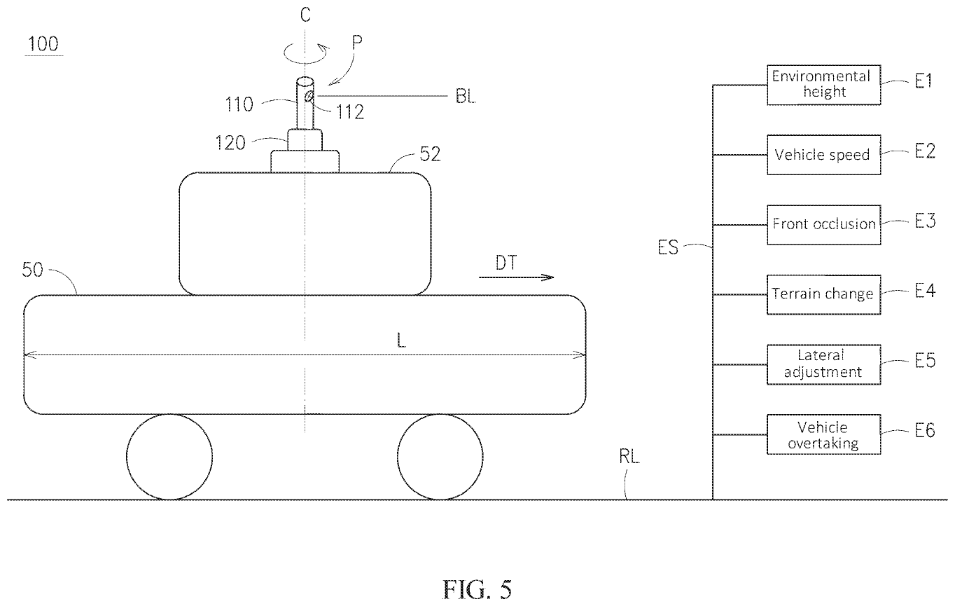

Then, in performing Step S120, according to an environmental scenario ES of that the vehicle body 50 encounters, determine whether or not there is an adjustment need. As shown in FIG. 5, possible environmental scenarios that the vehicle body 50 may encounter on the road are listed schematically. While the vehicle body 50 moves on a road RL in a driving direction DT, the vehicle body 50 may encounter various environmental scenarios ES, the environmental scenarios ES can include single event and/or multiple events such as an event of environmental height E1, an event of vehicle speed E2, an event of front occlusion E3, an event of terrain change E4, an event of lateral adjustment ES and an event of vehicle overtaking E6.

If Step S120 determines that a specific adjustment need does exist, then Step S130 is performed. While in performing Step S130, according to the adjustment need, the posture of the vehicular sensor would be adjusted. By having the system of FIG. 1 as a typical example, the control unit 130 would judge the environmental scenario ES to determine whether or not there is an adjustment need. If the adjustment need does exist, then the control unit 130 would evaluate the adjustment need to perform the automatic vehicular sensor adjustment method, and thus to output corresponding control signals. Based on the control signals from the control unit 130, the posture-adjusting mechanism 120 would adjust the posture P of the vehicular sensor 110, accordingly. In the following description, adjustments upon the height, inclination, facing angle and position of the vehicular sensor 100 with respect to the vehicle body 50 in Step S120 and Step S130 would be elucidated, respectively.

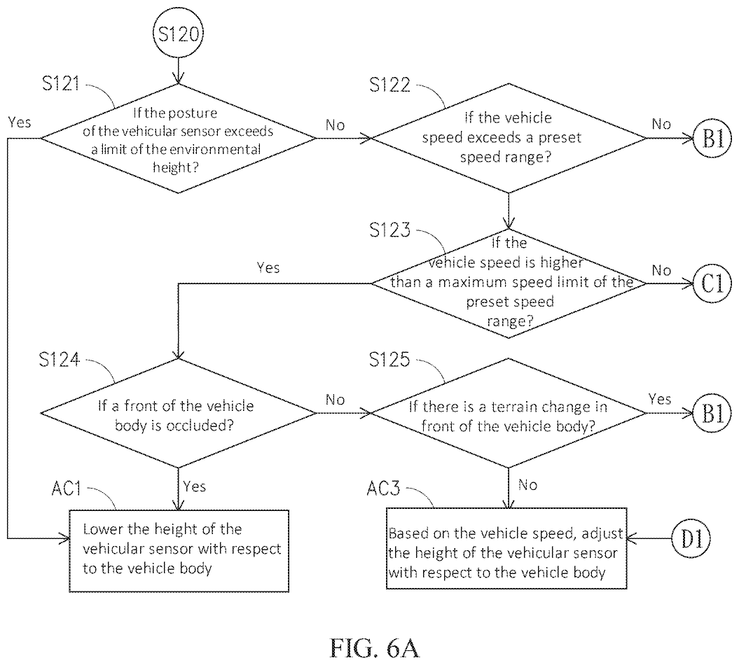

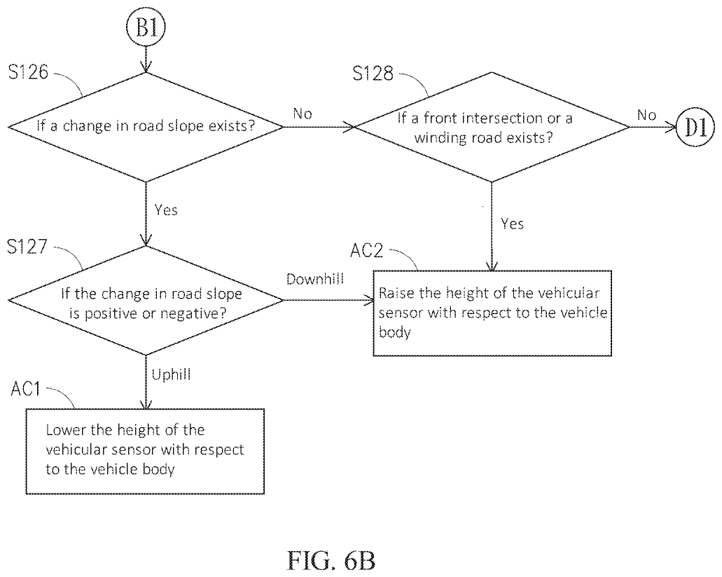

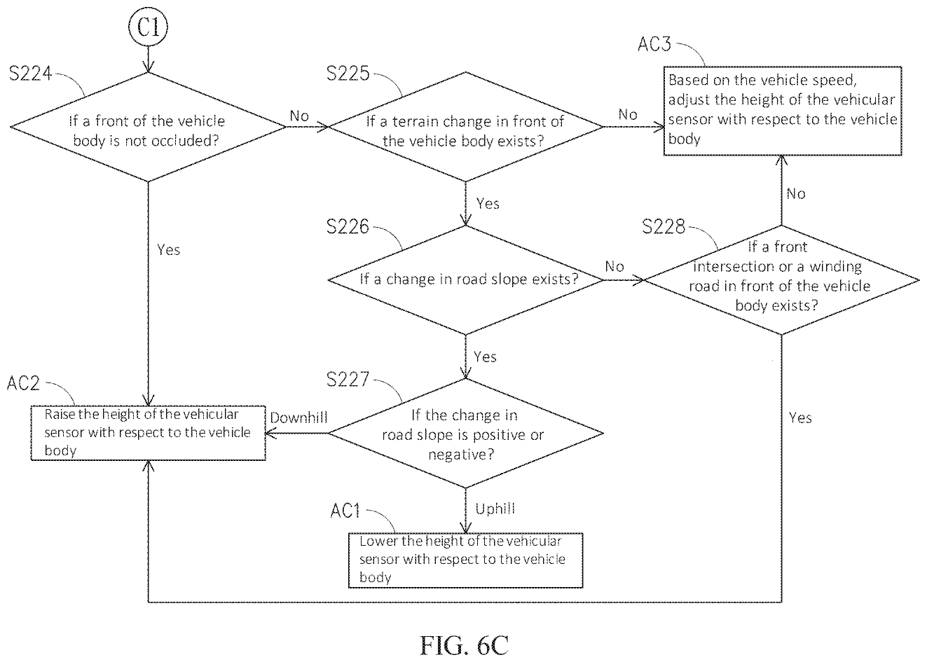

FIG. 6A through FIG. 6C are integrated to show schematically a flowchart of an embodiment of adjusting a height of a vehicle sensor according to the automatic vehicular sensor adjustment method of this disclosure. Refer firstly to FIG. 6A and FIG. 1, after Step S120 of FIG. 4 is performed, while in performing Step S121, it is determined whether or not the posture of the vehicular sensor 110 exceeds a limit of an environmental height; for example, the height limit for passing a tunnel, a basement or the like construction.

In Step S121, if the control unit 130 determines that the posture P of the vehicular sensor 110 exceeds the limit of the environmental height, then an adjustment need AC1 is to lower the height of the vehicular sensor 110 with respect to the vehicle body 50 so as to meet the limit of the environmental height. According to the adjustment need AC1, the control unit 130 issues corresponding control signals, and the posture-adjusting mechanism 120 follows the control signals from the control unit 130 to lower the height of the vehicular sensor 110 with respect to the vehicle body 50. In this embodiment, the posture-adjusting mechanism 120 would adjust the position of the vehicular sensor 110 to an extent of having a broader visible field without any collision. On the other hand, if the determination of Step S121 is negative, thus the control unit 130 determines that the posture P of the vehicular sensor 110 does not exceed the limit of the environmental height. In performing Step S122, it is determined whether or not the vehicle speed of the vehicle body 50 exceeds a preset speed range, in which the preset speed range is defined with a maximum speed limit and a minimum speed limit, according to the allowable driving speed range for individual road RL. For example, to a specific road RL having a maximum vehicle speed limit and a minimum vehicle speed limit, then the speed range between the maximum and the minimum vehicle speed limits would be defined as the preset speed range. If the determination of Step S122 is negative, thus the control unit 130 determines that the vehicle speed of the vehicle body 50 does not exceed the preset speed range. In other words, the instant vehicle speed of the vehicle body 50 is within the preset speed range. When the vehicle body 50 is operated within the preset speed range, the automatic vehicular sensor adjustment method S100 can be further advanced to Stage B1. After being advanced to Stage B1, Step S126 (see FIG. 6B) is performed firstly to determine whether or not a change in road slope exists, and then Step S128 is determined whether or not an intersection or a winding road in front of the vehicle body 50 exists. If the control unit 130 determines that the road slope is not changed, and neither an intersection nor a winding road exists in front of the vehicle body 50, then the control unit 130 may adjust the height of the vehicular sensor 110 with respect to the vehicle body 50, based on the instant vehicle speed. Such an adjustment can be a raise, a decrease, or a hold. Then, the method goes back to Stage A. According to Step S120, the control unit 130 would keep monitoring possible environmental scenarios that the vehicle body 50 encounters to determine whether or not a response adjustment is needed.

If the determination of Step S122 is positive, thus the control unit 130 determines that the vehicle speed of the vehicle body 50 exceeds the preset speed range. In other words, the instant vehicle speed of the vehicle body 50 is beyond the preset speed range. At this time, the instant vehicle speed of the vehicle body 50 may be higher than the maximum speed limit of the preset speed range, or lower than the minimum speed limit of the preset speed range. Then, in performing Step S123, it is determined whether or not the vehicle speed of the vehicle body 50 is higher than the maximum speed limit of the preset speed range. The maximum speed limit can be defined by the maximum vehicle speed limit setup for individual road RL. In other words, if the control unit 130 determines that the vehicle speed of the vehicle body 50 goes beyond the preset speed range, then the control unit 130 further determines whether or not the vehicle speed of the vehicle body 50 is too fast. If the control unit 130 determines that the vehicle speed of the vehicle body 50 is higher than the maximum speed limit of the preset speed range, then it implies that the vehicle speed of the vehicle body 50 is too fast. Then, in performing Step S124, it is determined whether or not the front of the vehicle body 50 is occluded. In other words, the event of vehicle speed E2 and further the event of front occlusion E3 of FIG. 5 are integrated as the environmental scenario to determine whether or not another adjustment need is followed up. However, FIG. 6A is simply an exemplary example to show a feasible determination order, not for limiting the scope of this disclosure. It shall be explained that, generally speaking, if the control unit 130 determines that the vehicle speed of the vehicle body 50 is higher than the maximum speed limit of the preset speed range, the vehicle speed of the vehicle body 50 is usually too fast. Then, the adjustment need would be to raise the height of the vehicular sensor 110 with respect to the vehicle body 50, and thus the control unit 130 would evaluate the adjustment need to output corresponding control signals. Then, based on the control signals from the control unit 130, the posture-adjusting mechanism 120 would raise the height of the vehicular sensor 110 with respect to the vehicle body 50, so that the detected region of the vehicular sensor 110 would be farther. On the other hand, if the control unit 130 determines that the vehicle speed of the vehicle body 50 is not larger than the maximum speed limit of the preset speed range, and further the control unit 130 determines whether or not the vehicle speed of the vehicle body 50 is lower than the minimum speed limit of the preset speed range. If the control unit 130 determines that the vehicle speed of the vehicle body 50 is lower than the minimum speed limit of the preset speed range, then it implies that the vehicle speed of the vehicle body 50 is too slow. At this time, the environmental situations surrounding the vehicle body 50 would be more important, and thus the adjustment need would be to lower the height of the vehicular sensor 110 with respect to the vehicle body 50. Thereupon, the control unit 130 would evaluate the adjustment need to issue corresponding control signals, and the posture-adjusting mechanism 120 would follow the control signals from the control unit 130 to lower the height of the vehicular sensor 110 with respect to the vehicle body 50, so that the detected region of the vehicular sensor 110 would be closer.

Refer back to FIG. 6A. In Step S124, if the control unit 130 determines that the front of the vehicle body 50 is occluded, then, from the determination of Step S123, it is understood that the instant vehicle speed of the vehicle body 50 is faster. Thereupon, the adjustment need AC1 would be to lower the height of the vehicular sensor 110 with respect to the vehicle body 50. According to the adjustment need AC1, the control unit 130 would issue corresponding control signals, and the posture-adjusting mechanism 120 follows the control signals from the control unit 130 to lower the height of the vehicular sensor 110 with respect to the vehicle body 50. Thus, as the front of the vehicle body 50 is occluded, if the vehicle speed of the vehicle body 50 is faster, then the vehicular sensor 110 shall focus at the closer detected region, and thus the height of the vehicular sensor 110 with respect to the vehicle body 50 is lowered to follow the nearby obstacles. However, the present disclosure is not limited to the aforesaid embodiments. In one embodiment not shown here, the control unit 130 can determine that the front of the vehicle body 50 is occluded. Through adjusting the height of the vehicular sensor 110 with respect to the vehicle body 50, the detected region of the vehicular sensor 110 can be drawn closer to follow or go across the obstacle.

In this embodiment, in Step S124, if the control unit 130 determines that the front of the vehicle body 50 is not occluded, then, in performing Step S125, it is determined whether or not there is a terrain change in front of the vehicle body 50. It shall be explained that the term “terrain change ” stands for a change of the road slope, an intersection in front of the vehicle body 50, or a winding road in front of the vehicle body 50. In this embodiment, the control unit 130 determines that the vehicle body 50 won't meet a terrain change, then the adjustment need AC3 is to evaluate the vehicle speed to adjust the height of the vehicular sensor 110 with respect to the vehicle body 50. In other words, according to the adjustment need AC3, the control unit 130 would issue corresponding control signals. If the vehicle speed of the vehicle body 50 is faster, based on the control signals from the control unit 130, the posture-adjusting mechanism 120 would raise the height of the vehicular sensor 110 with respect to the vehicle body 50. On the other hand, if the vehicle speed of the vehicle body 50 is slower, based on the control signals from the control unit 130, the posture-adjusting mechanism 120 would lower the height of the vehicular sensor 110 with respect to the vehicle body 50.

In this embodiment, in Step S125, if the control unit 130 determines that a terrain change in front of the vehicle body exists, then, based on the event of terrain change, the posture of the vehicular sensor 110 would be adjusted. In detail, as Step S125 determined that a terrain change in front of the vehicle body 50 does exist, then the automatic vehicular sensor adjustment method S100 can be further advanced to Stage B1. After being advanced to Stage B1, Step S126 (see FIG. 6B) is performed firstly to determine whether or not a change in road slope exists. If the control unit 130 determines that a change in the road slope does exist, then, in performing Step S127, it is determined whether or not the road slope is positive or negative. If the control unit 130 determines that the road slope is positive, then the adjustment need AC1 is to lower the height of the vehicular sensor 110 with respect to the vehicle body 50. According to the adjustment need AC1, the control unit 130 issues corresponding control signals, and the posture-adjusting mechanism 120 follows the control signals from the control unit 130 to lower the height of the vehicular sensor 110 with respect to the vehicle body 50, so that, when the vehicle body 50 goes uphill, the posture-adjusting mechanism 120 would adjust the position of the vehicular sensor 110 to move the detected region closer. Thereupon, laser beams emitted by the vehicular sensor 110 can be prevented from projecting into the air or to a farther position. On the other hand, if the control unit 130 determines that the road slope is negative, then the adjustment need AC2 is to raise the height of the vehicular sensor 110 with respect to the vehicle body 50. According to the adjustment need AC2, the control unit 130 issues corresponding control signals, and the posture-adjusting mechanism 120 follows the control signals from the control unit 130 to raise the height of the vehicular sensor 110 with respect to the vehicle body 50, so that, when the vehicle body 50 goes downhill, the posture-adjusting mechanism 120 would adjust the position of the vehicular sensor 110 to move the detected region farther. For example, for a downhill road to connect a horizontal road, when the vehicle body 50 goes downhill, a farther object at the horizontal road can be visibly located by raising the height of the vehicular sensor 110 with respect to the vehicle body 50.

In this embodiment, in Step S126, if the control unit 130 determines that a change in road slope does not exist, then, in performing Step S128, it is determined whether or not an intersection or a winding road in front of the vehicle body 50 exists. If the control unit 130 determines that an intersection or a winding road in front of the vehicle body 50 does not exist, then the method S100 goes to Stage D1. As shown in FIG. 6A, the adjustment need AC3 would be to evaluate the vehicle speed to adjust the height of the vehicular sensor 110 with respect to the vehicle body 50. On the other hand, if the control unit 130 determines that an intersection or a winding road in front of the vehicle body 50 does exist, the adjustment need AC2 would be to raise the height of the vehicular sensor 110 with respect to the vehicle body 50. According to the adjustment need AC2, the control unit 130 issues corresponding control signals, and the posture-adjusting mechanism 120 follows the control signals from the control unit 130 to raise the height of the vehicular sensor 110 with respect to the vehicle body 50, so that, when an intersection or a winding road in front of the vehicle body 50 does exist, the posture-adjusting mechanism 120 would adjust the position of the vehicular sensor 110 to move the detected region farther. Thereupon, the road situation ahead of the vehicle body 50 (such as a front intersection or a winding road) can be confirmed, so that the vehicle body 50 would be able to perform selection of driving behaviors.

In this embodiment, the aforesaid Step S124 to Step S128 are performed upon when Step S123 determines that the vehicle speed of the vehicle body 50 is faster. Referring back to FIG. 6A, Step S122 is performed to determine whether or not the vehicle speed of the vehicle body 50 exceeds the preset speed range; i.e., higher than the maximum speed limit of the preset speed range, or lower than the minimum speed limit of the preset speed range. Then, in Step S123, if the control unit 130 determines that the vehicle speed of the vehicle body 50 is not higher than the maximum speed limit of the preset speed range, then the control unit 130 determines further whether or not the vehicle speed of the vehicle body 50 is lower than the minimum speed limit of the preset speed range. If the control unit 130 determines that the vehicle speed of the vehicle body 50 is lower than the minimum speed limit of the preset speed range, then it implies that the vehicle speed of the vehicle body 50 is slower, and thus the method S100 goes to Stage C1. Referring further to FIG. 6C, in performing Step S224, it is determined whether or not the front of the vehicle body 50 is occluded. If the control unit 130 determines that the front of the vehicle body 50 is occluded, then, from the determinations of Step S122 and Step S123, it is known that the vehicle speed of the vehicle body 50 is slower, and the adjustment need AC2 is to raise the height of the vehicular sensor 110 with respect to the vehicle body 50. According to the adjustment need AC2, the control unit 130 issues corresponding control signals, and the posture-adjusting mechanism 120 follows the control signals from the control unit 130 to raise the height of the vehicular sensor 110 with respect to the vehicle body 50, so that, when the front view of the vehicle body 50 is limited and the vehicle speed is slower, the posture-adjusting mechanism 120 would adjust the position of the vehicular sensor 110 to move the detected region farther, so that the detected region of the vehicular sensor 110 can go across the obstacle to confirm if there is another obstacle to come, or to confirm the road situations in front of the vehicle body 50 (such as an intersection or a winding road). Thus, the vehicle body 50 would be able to perform selection of driving behaviors. However, the present disclosure is not limited to the aforesaid embodiments. In one embodiment not shown here, the control unit 130 can determine that the front of the vehicle body 50 is occluded. Through adjusting the height of the vehicular sensor 110 with respect to the vehicle body 50, the detected region of the vehicular sensor 110 can be drawn closer or farther so as to follow or go across the obstacle.

In this embodiment, in Step S224, if the control unit 130 determines that the front of the vehicle body 50 is not occluded, then, in performing Step S225, it is determined further whether or not a terrain change in front of the vehicle body 50 exists. If the control unit 130 determines that the vehicle body 50 won't meet a terrain change, then the adjustment need AC3 is to evaluate the vehicle speed to adjust the height of the vehicular sensor 110 with respect to the vehicle body 50. In Step S225, if the control unit 130 determines that a terrain change in front of the vehicle body exists, then, in Step S226, it is performed to determine whether or not a change in road slope exists. If the control unit 130 determines that a change in the road slope does exist, then, in performing Step S227, it is determined whether or not the road slope is positive or negative. If the control unit 130 determines that the road slope is positive, then the adjustment need AC1 is to lower the height of the vehicular sensor 110 with respect to the vehicle body 50. According to the adjustment need AC1, the control unit 130 issues corresponding control signals, and the posture-adjusting mechanism 120 follows the control signals from the control unit 130 to lower the height of the vehicular sensor 110 with respect to the vehicle body 50, so that, when the vehicle body 50 goes uphill, the posture-adjusting mechanism 120 would adjust the position of the vehicular sensor 110 to move the detected region closer. Thereupon, laser beams emitted by the vehicular sensor 110 can be prevented from projecting into the air or to a farther position. On the other hand, if the control unit 130 determines that the road slope is negative, then the adjustment need AC2 is to raise the height of the vehicular sensor 110 with respect to the vehicle body 50. According to the adjustment need AC2, the control unit 130 issues corresponding control signals, and the posture-adjusting mechanism 120 follows the control signals from the control unit 130 to raise the height of the vehicular sensor 110 with respect to the vehicle body 50, so that a farther object at the horizontal road connecting the downhill road can be visibly located.

In this embodiment, in Step S226, if the control unit 130 determines that a change in road slope does not exist, then, in performing Step S228, it is determined whether or not an intersection or a winding road in front of the vehicle body 50 exists. If the control unit 130 determines that an intersection or a winding road in front of the vehicle body 50 does not exist, then the adjustment need AC3 would be to evaluate the vehicle speed to adjust the height of the vehicular sensor 110 with respect to the vehicle body 50. On the other hand, if the control unit 130 determines that an intersection or a winding road in front of the vehicle body 50 does exist, the adjustment need AC2 would be to raise the height of the vehicular sensor 110 with respect to the vehicle body 50. According to the adjustment need AC2, the control unit 130 issues corresponding control signals, and the posture-adjusting mechanism 120 follows the control signals from the control unit 130 to raise the height of the vehicular sensor 110 with respect to the vehicle body 50, so that the road situation ahead of the vehicle body 50 (such as a front intersection or a winding road) can be confirmed, so that the vehicle body 50 would be able to perform selection of driving behaviors.

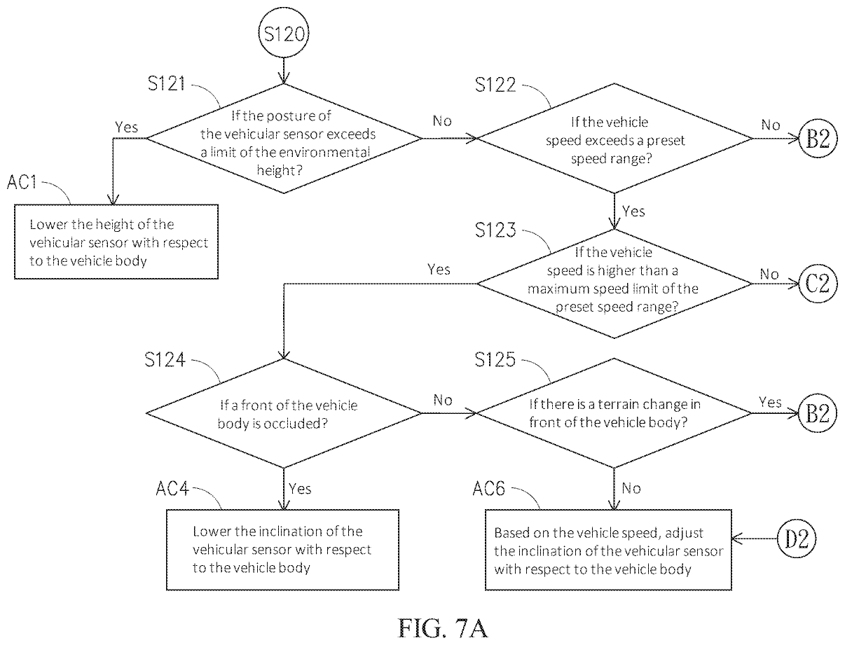

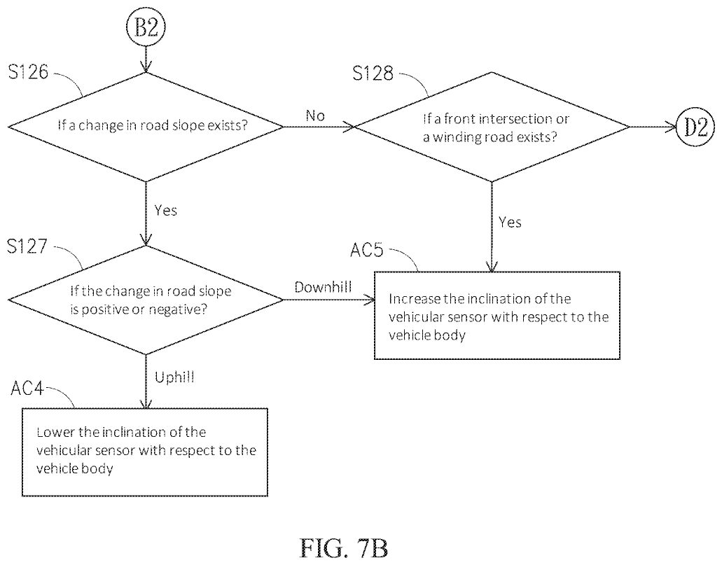

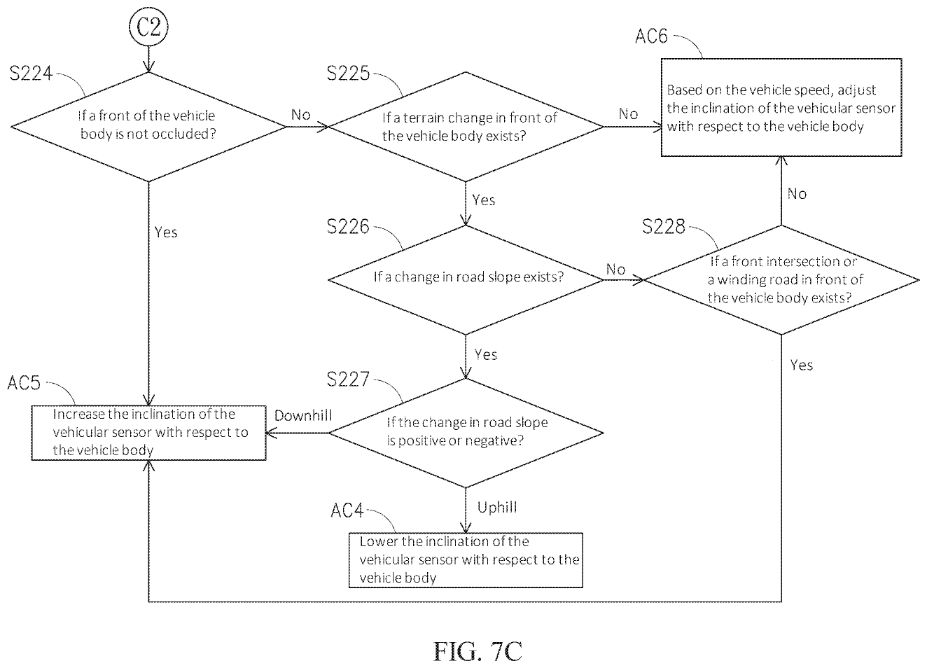

FIG. 7A through FIG. 7C are integrated to show schematically a flowchart of an embodiment of adjusting an inclination of a vehicle sensor according to the automatic vehicular sensor adjustment method of this disclosure. It shall be explained that the automatic vehicular sensor adjustment method of FIG. 7A to FIG. 7C and the automatic vehicular sensor adjustment method of FIG. 6A to FIG. 6C are largely similar Thus, the same steps would be assigned by the same numbers, and details thereabout would be omitted herein. In the following description about the aforesaid method of FIG. 7A to FIG. 7C, only the difference to that of FIG. 6A to FIG. 6C will be elucidated. Referring now to FIG. 7A and FIG. 1, Then, in performing Step S123, it is determined whether or not the vehicle speed of the vehicle body 50 is higher than the maximum speed limit of the preset speed range. The maximum speed limit can be defined by the maximum vehicle speed limit setup for individual road RL. In other words, if the control unit 130 determines that the vehicle speed of the vehicle body 50 goes beyond the preset speed range, then the control unit 130 further determines whether or not the vehicle speed of the vehicle body 50 is too fast. If the control unit 130 determines that the vehicle speed of the vehicle body 50 is higher than the maximum speed limit of the preset speed range, then it implies that the vehicle speed of the vehicle body 50 is too fast. Then, in performing Step S124, it is determined whether or not the front of the vehicle body 50 is occluded. In other words, the event of vehicle speed E2 and further the event of front occlusion E3 of FIG. 5 are integrated as the environmental scenario to determine whether or not another adjustment need is followed up. However, FIG. 7A is simply an exemplary example to show a feasible determination order, not for limiting the scope of this disclosure. It shall be explained that, generally speaking, if the control unit 130 determines that the vehicle speed of the vehicle body 50 is higher than the maximum speed limit of the preset speed range, the vehicle speed of the vehicle body 50 is usually too fast. Then, the adjustment need would be to increase the inclination of the vehicular sensor 110 with respect to the vehicle body 50, and thus the control unit 130 would evaluate the adjustment need to output corresponding control signals. Then, based on the control signals from the control unit 130, the posture-adjusting mechanism 120 would increase the inclination of the vehicular sensor 110 with respect to the vehicle body 50, so that the detected region of the vehicular sensor 110 would be farther. On the other hand, if the control unit 130 determines that the vehicle speed of the vehicle body 50 is not larger than the maximum speed limit of the preset speed range, and further the control unit 130 determines whether or not the vehicle speed of the vehicle body 50 is lower than the minimum speed limit of the preset speed range. If the control unit 130 determines that the vehicle speed of the vehicle body 50 is lower than the minimum speed limit of the preset speed range, then it implies that the vehicle speed of the vehicle body 50 is too slow. At this time, the environmental situations surrounding the vehicle body 50 would be more important, and thus the adjustment need would be to lower the inclination of the vehicular sensor 110 with respect to the vehicle body 50. Thereupon, the control unit 130 would evaluate the adjustment need to issue corresponding control signals, and the posture-adjusting mechanism 120 would follow the control signals from the control unit 130 to lower the inclination of the vehicular sensor 110 with respect to the vehicle body 50, so that the detected region of the vehicular sensor 110 would be closer. In addition, in Step S122, if the control unit 130 determines that the vehicle speed of the vehicle body 50 is within the preset speed range, thus the vehicle body 50 is operated within the preset speed range. The automatic vehicular sensor adjustment method S100 would be further advanced to Stage B2. After being advanced to Stage B2, Step S126 (see FIG. 7B) is performed firstly to determine whether or not a change in road slope exists, and then Step S128 is determined whether or not an intersection or a winding road in front of the vehicle body 50 exists. If the control unit 130 determines that the road slope is not changed, and neither an intersection nor a winding road exists in front of the vehicle body 50, then the control unit 130 may adjust the inclination of the vehicular sensor 110 with respect to the vehicle body 50, based on the instant vehicle speed. Such an adjustment can be a raise, a decrease, or a hold. Then, the method goes back to Stage A. According to Step S120, the control unit 130 would keep monitoring possible environmental scenarios of the vehicle body 50 to determine whether or not a response adjustment is needed.

Refer back to FIG. 7A. In Step S124, if the control unit 130 determines that the front of the vehicle body 50 is occluded, then, from the determination of Step S123, it is understood that the instant vehicle speed of the vehicle body 50 is faster. Thereupon, the adjustment need AC4 would be to lower the inclination of the vehicular sensor 110 with respect to the vehicle body 50. According to the adjustment need AC4, the control unit 130 would issue corresponding control signals, and the posture-adjusting mechanism 120 follows the control signals from the control unit 130 to lower the inclination of the vehicular sensor 110 with respect to the vehicle body 50. Thus, as the front visible field of the vehicle body 50 is occluded, if the vehicle speed of the vehicle body 50 is faster, then the vehicular sensor 110 shall focus at the closer detected region, and thus the inclination of the vehicular sensor 110 with respect to the vehicle body 50 is lowered to follow the nearby obstacles. However, the present disclosure is not limited to the aforesaid embodiments. In one embodiment not shown here, the control unit 130 can determine that the front of the vehicle body 50 is occluded. Through adjusting the inclination of the vehicular sensor 110 with respect to the vehicle body 50, the detected region of the vehicular sensor 110 can be drawn closer to follow or go across the obstacle.

In this embodiment, in Step S124, if the control unit 130 determines that the front of the vehicle body 50 is not occluded, then, in performing Step S125, it is determined whether or not a terrain change in front of the vehicle body 50 exists. If the control unit 130 determines that the vehicle body 50 won't meet a terrain change, then the adjustment need AC6 is to evaluate the vehicle speed to adjust the inclination of the vehicular sensor 110 with respect to the vehicle body 50. In other words, according to the adjustment need AC6, the control unit 130 would issue corresponding control signals. If the vehicle speed of the vehicle body 50 is faster, based on the control signals from the control unit 130, the posture-adjusting mechanism 120 would increase the inclination of the vehicular sensor 110 with respect to the vehicle body 50. On the other hand, if the vehicle speed of the vehicle body 50 is slower, based on the control signals from the control unit 130, the posture-adjusting mechanism 120 would lower the inclination of the vehicular sensor 110 with respect to the vehicle body 50.

In this embodiment, in Step S125, if the control unit 130 determines that a terrain change in front of the vehicle body exists, then the automatic vehicular sensor adjustment method S100 can be further advanced to Stage B2. After being advanced to Stage B2, Step S126 (see FIG. 7B) is performed firstly to determine whether or not a change in road slope exists. If the control unit 130 determines that a change in the road slope does exist, then, in performing Step S127, it is determined whether or not the road slope is positive (i.e., an uphill) or negative (i.e., a downhill) If the control unit 130 determines that the road slope is positive, then the adjustment need AC4 is to lower the inclination of the vehicular sensor 110 with respect to the vehicle body 50. According to the adjustment need AC4, the control unit 130 issues corresponding control signals, and the posture-adjusting mechanism 120 follows the control signals from the control unit 130 to lower the inclination of the vehicular sensor 110 with respect to the vehicle body 50, so that, when the vehicle body 50 goes uphill, the posture-adjusting mechanism 120 would adjust the position of the vehicular sensor 110 to move the detected region closer. Thereupon, laser beams emitted by the vehicular sensor 110 can be prevented from projecting into the air or to a farther position. On the other hand, if the control unit 130 determines that the road slope is a negative, then the adjustment need AC5 is to increase the inclination of the vehicular sensor 110 with respect to the vehicle body 50. According to the adjustment need ACS, the control unit 130 issues corresponding control signals, and the posture-adjusting mechanism 120 follows the control signals from the control unit 130 to raise the inclination of the vehicular sensor 110 with respect to the vehicle body 50, so that a farther object at the horizontal road following the downhill road can be visibly located by increasing the inclination of the vehicular sensor 110 with respect to the vehicle body 50.

In this embodiment, in Step S126, if the control unit 130 determines that a change in road slope does not exist, then, in performing Step S128, it is determined whether or not an intersection or a winding road in front of the vehicle body 50 exists. If the control unit 130 determines that an intersection or a winding road in front of the vehicle body 50 does not exist, then the method 5100 goes to Stage D2. As shown in FIG. 7A, the adjustment need AC6 would be to evaluate the vehicle speed to adjust the inclination of the vehicular sensor 110 with respect to the vehicle body 50. On the other hand, if the control unit 130 determines that an intersection or a winding road in front of the vehicle body 50 does exist, the adjustment need AC5 would be to increase the inclination of the vehicular sensor 110 with respect to the vehicle body 50. According to the adjustment need AC5, the control unit 130 issues corresponding control signals, and the posture-adjusting mechanism 120 follows the control signals from the control unit 130 to increase the inclination of the vehicular sensor 110 with respect to the vehicle body 50, so that, when an intersection or a winding road in front of the vehicle body 50 does exist, the posture-adjusting mechanism 120 would adjust the position of the vehicular sensor 110 to move the detected region farther. Thereupon, the road situation ahead of the vehicle body 50 (such as a front intersection or a winding road) can be confirmed, so that the vehicle body 50 would be able to perform selection of driving behaviors.

In this embodiment, the aforesaid Step S124 to Step S128 are performed upon when Step S123 determines that the vehicle speed of the vehicle body 50 is faster. Referring back to FIG. 7A, Step S122 is performed to determine whether or not the vehicle speed of the vehicle body 50 exceeds the preset speed range; i.e., higher than the maximum speed limit of the preset speed range, or lower than the minimum speed limit of the preset speed range. Then, in Step S123, if the control unit 130 determines that the vehicle speed of the vehicle body 50 is not higher than the maximum speed limit of the preset speed range, then the control unit 130 determines further whether or not the vehicle speed of the vehicle body 50 is lower than the minimum speed limit of the preset speed range. If the control unit 130 determines that the vehicle speed of the vehicle body 50 is lower than the minimum speed limit of the preset speed range, then it implies that the vehicle speed of the vehicle body 50 is slower, and thus the method S100 goes to Stage C2. Referring further to FIG. 6C, in performing Step S224, it is determined whether or not an occlusion in front of the vehicle body 50 exists. If the control unit 130 determines that a occlusion in front of the vehicle body 50 exists, then, from the determinations of Step S122 and Step S123, it is known that the vehicle speed of the vehicle body 50 is slower, and the adjustment need AC5 is to raise the inclination of the vehicular sensor 110 with respect to the vehicle body 50. According to the adjustment need AC5, the control unit 130 issues corresponding control signals, and the posture-adjusting mechanism 120 follows the control signals from the control unit 130 to increase the inclination of the vehicular sensor 110 with respect to the vehicle body 50, so that, when the front view of the vehicle body 50 is limited and the vehicle speed is slower, the posture-adjusting mechanism 120 would adjust the position of the vehicular sensor 110 to move the detected region farther, so that the detected region of the vehicular sensor 110 can go across the obstacle to confirm if there is another obstacle to come, or to confirm the road situations in front of the vehicle body 50 (such as an intersection or a winding road). Thus, the vehicle body 50 would be able to perform selection of driving behaviors.

In this embodiment, in Step S224, if the control unit 130 determines that the front of the vehicle body 50 is not occluded, then, in performing Step S225, it is determined further whether or not a terrain change in front of the vehicle body 50 exists. If the control unit 130 determines that the vehicle body 50 won't meet a terrain change, then the adjustment need AC6 is to evaluate the vehicle speed to adjust the height of the vehicular sensor 110 with respect to the vehicle body 50. In Step S225, if the control unit 130 determines that a terrain change in front of the vehicle body exists, then, in Step S226, it is performed to determine whether or not a change in road slope exists. If the control unit 130 determines that a change in the road slope does exist, then, in performing Step S227, it is determined whether or not the road slope is positive or negative. If the control unit 130 determines that the road slope is positive, then the adjustment need AC4 is to lower the inclination of the vehicular sensor 110 with respect to the vehicle body 50. According to the adjustment need AC4, the control unit 130 issues corresponding control signals, and the posture-adjusting mechanism 120 follows the control signals from the control unit 130 to lower the inclination of the vehicular sensor 110 with respect to the vehicle body 50, so that, when the vehicle body 50 goes uphill, the posture-adjusting mechanism 120 would adjust the position of the vehicular sensor 110 to move the detected region closer. Thereupon, laser beams emitted by the vehicular sensor 110 can be prevented from projecting into the air or to a farther position. On the other hand, if the control unit 130 determines that the road slope is negative, then the adjustment need AC5 is to raise the inclination of the vehicular sensor 110 with respect to the vehicle body 50. According to the adjustment need AC5, the control unit 130 issues corresponding control signals, and the posture-adjusting mechanism 120 follows the control signals from the control unit 130 to increase the inclination of the vehicular sensor 110 with respect to the vehicle body 50, so that a farther object at the horizontal road connecting the downhill road can be visibly located.

In this embodiment, in Step S226, if the control unit 130 determines that a change in road slope does not exist, then, in performing Step S228, it is determined whether or not an intersection or a winding road in front of the vehicle body 50 exists. If the control unit 130 determines that an intersection or a winding road in front of the vehicle body 50 does not exist, then the adjustment need AC6 would be to evaluate the vehicle speed to adjust the inclination of the vehicular sensor 110 with respect to the vehicle body 50. On the other hand, if the control unit 130 determines that an intersection or a winding road in front of the vehicle body 50 does exist, the adjustment need AC5 would be to increase the inclination of the vehicular sensor 110 with respect to the vehicle body 50. According to the adjustment need AC5, the control unit 130 issues corresponding control signals, and the posture-adjusting mechanism 120 follows the control signals from the control unit 130 to increase the inclination of the vehicular sensor 110 with respect to the vehicle body 50

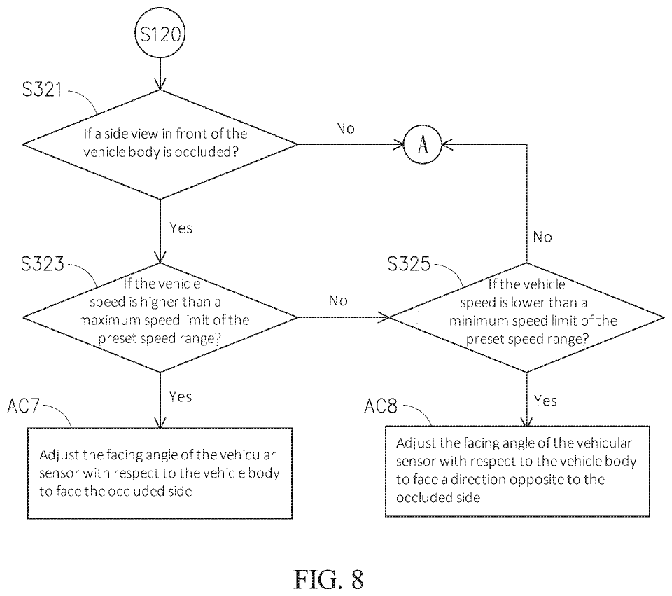

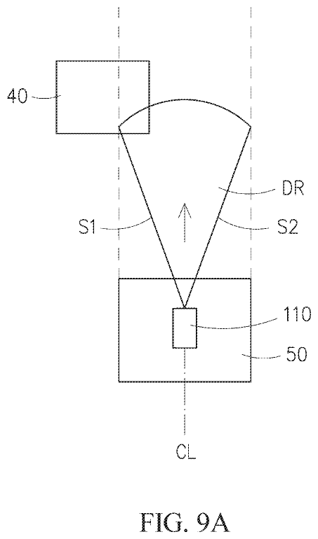

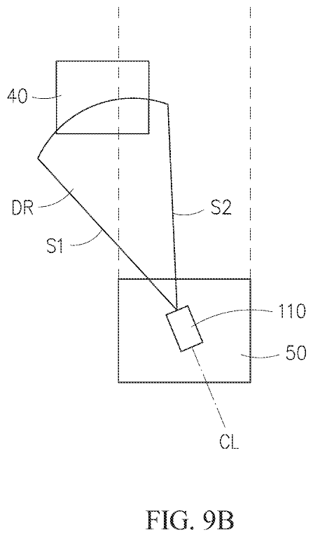

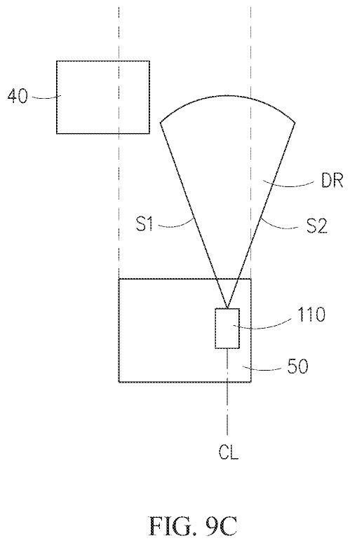

Refer now to FIG. 8 to FIG. 9B; where FIG. 8 is a schematic flowchart of an embodiment of adjusting a facing angle of a vehicle sensor according to the automatic vehicular sensor adjustment method of this disclosure, FIG. 9A shows schematically an exemplary example that the environmental scenario of the vehicle body is an event of lateral adjustment, and FIG. 9B shows another state of FIG. 9A. It is shown that FIG. 8 and FIG. 9A are used to elucidate an exemplary example related to the event of lateral adjustment E5 of FIG. 5. It shall be explained that, generally speaking, as shown in FIG. 2, in the case that the vehicular sensor 110 is a LiDAR, the sensing portion 112 can perform a 360-degree detection. In the following description upon the facing angle of the vehicular sensor 110 with respect to the vehicle body 50, the sensing portion 112 of the vehicular sensor 110, assumed not to perform a 360-degree detection, is to, by rotating the vehicular sensor 110 about the centerline C, aim at a target object, provide a directing direction, or to provide a reference direction while in mounting. As shown in FIG. 8, after Step S120 of FIG. 4 is performed, in performing Step S321, it is determined whether or not a side view in front of the vehicle body 50 is occluded. As shown in FIG. 9A, while the vehicle body 50 is operated on the road, the vehicular sensor 110 has a detection range DR, confined by a first side S1 and a second side S2 located to opposing sides of the detected centerline CL. It shall be explained that the term “lateral adjustment” is directed to a scenario that only a portion of the detection range DR of the vehicular sensor 110, excluding the detected centerline CL, is occluded. Namely, for a lateral adjustment, the portion to be occluded is less than one half of the detection range DR. On the other hand, if an obstacle occludes at least the detected centerline CL of the detection range DR, then this situation is attributed to the aforesaid occlusion in front of the vehicle body 50. As shown in FIG. 9A, an obstacle 40 located on the left front of the vehicle body 50 blocks the first side S1 of the detection range DR of the vehicular sensor 110, and thus an event of lateral adjustment is encountered. At this time, the first side S1 is called as an occluded side, as shown in FIG. 9A.

In this embodiment, in Step S321, if the control unit 130 determines that the vehicle body 50 does not encounter an event of lateral adjustment, then no adjustment need to the vehicle body 50 is necessary, and the method 5100 goes back to Stage A, i.e., to Step S120 of FIG. 4. Thus, the control unit 130 would keep monitoring possible environmental scenarios to the vehicle body 50 so as to determine whether or not an adjustment need is necessary. On the other hand, if the control unit 130 determines that vehicle body 50 does encounter an event of lateral adjustment, then, in Step S323, it is determined whether or not the vehicle speed of the vehicle body 50 is higher than a maximum speed limit of the preset speed range. The maximum speed limit of the preset speed range is dependent of the maximum vehicle speed limit of individual road RL. In other words, in this step, the control unit 130 is to determine whether or not the vehicle speed of the vehicle body 50 is too fast. If the control unit 130 determines that the vehicle speed of the vehicle body 50 is higher than the maximum speed limit of the preset speed rang, it implies that the vehicle speed of the vehicle body 50 is too high, and then an adjustment need AC7 is introduced to adjust the facing angle (i.e., the angling) of the vehicular sensor 110 with respect to the vehicle body 50 by turning to face the occluded side. According to the adjustment need AC7, the control unit 130 would issue corresponding control signals, and the posture-adjusting mechanism 120 would follow the control signals from the control unit 13 to adjust the facing angle of the vehicular sensor 110 with respect to the vehicle body 50, preferably by having the facing angle to be right at the occluded side. As shown in FIG. 9B, when a side view in front of the vehicle body 50 is occluded by an obstacle 40, and if the instant vehicle speed of the vehicle body 50 is too fast, then the vehicular sensor 110 shall focus at a detected region close to the obstacle 40, and thus the facing angle of the vehicular sensor 110 with respect to the vehicle body 50 would be adjusted to face the first side S1 so as to cover the obstacle 40.

In this embodiment, in Step S323, if the vehicle speed of the vehicle body 50 is not higher than the maximum speed limit of the preset speed range, then, in performing Step S325, it is determined whether or not the vehicle speed of the vehicle body 50 is lower than the minimum speed limit of the preset speed range. The minimum speed limit of the preset speed range is dependent of the allowable lowest vehicle speed limit of individual road RL. If the determination of Step S325 is negative, it implies that the vehicle speed of the vehicle body 50 is not lower than the minimum speed limit of the preset speed range, and, in Step S323, the control unit 130 determines that the vehicle speed of the vehicle body 50 is not higher than the maximum speed limit of the preset speed range. Thus, it implies that the vehicle speed of the vehicle body 50 is within the preset speed range. In other words, at this moment, an adjustment need for the vehicle body 50 is not necessary, and the method S100 goes back to Stage A; i.e., Step S120 of FIG. 4. Thereupon, the control unit 130 can keep monitoring possible environmental scenarios of the vehicle body 50, so as to judge whether or not an adjustment need is necessary. On the other hand, if the determination of Step S325 is positive, then the vehicle speed of the vehicle body 50 is lower than the minimum speed limit of the preset speed range. Namely, the instant vehicle speed of the vehicle body 50 is slower. At this time, the adjustment need AC8 would be to adjust the facing angle of the vehicular sensor 110 with respect to the vehicle body 50 by turning the facing angle to a direction opposite to the occluded side. According to the adjustment need AC8, the control unit 130 would issue corresponding control signals, and the posture-adjusting mechanism 120 would evaluate the control signals from the control unit 130 to adjust the facing angle of the vehicular sensor 110 with respect to the vehicle body 50 by turning the facing angle to a direction opposite to the occluded side. When the side view in front of the vehicle body 50 is occluded, and if the instant vehicle speed of the vehicle body 50 is slower, then the vehicular sensor 110 shall have a farther detected region, or needn't follow the obstacle, and thus the facing angle of the vehicular sensor 110 with respect to the vehicle body 50 would be turned to face the second side S2 so as to prevent from following the obstacle 40.

In FIG. 8 and FIG. 9B, the adjustment need for the lateral adjustment E5 (as the environmental scenario ES) of FIG. 9A is to adjust the facing angle of the vehicular sensor 110 with respect to the vehicle body 50. However, the present disclosure is not limited by the aforesaid embodiment. In another embodiment, the adjustment need for the lateral adjustment E5 (as the environmental scenario ES) of FIG. 9A can be also done by adjusting the position of the vehicular sensor 110 with respect to the vehicle body 50. Steps of this adjustment need are largely resembled to steps of FIG. 8, in which the same steps would be assigned by the same numbers, and details thereabout would be omitted herein. In the following description about the steps related to FIG. 9C, only the difference to that to FIG. 9A will be elucidated. As shown in FIG. 9C, a further adjustment from FIG. 9A is shown, in which the position of the vehicular sensor 110 with respect to the vehicle body 50 is adjusted. In Step S323 of FIG. 8, it is determined whether or not the vehicle speed of the vehicle body 50 is higher than the maximum speed limit of the preset speed range. If the control unit 130 determines that the vehicle speed of the vehicle body 50 is higher than the maximum speed limit of the preset speed rang, it implies that the vehicle speed of the vehicle body 50 is too high, and then an adjustment need is introduced to adjust the position of the vehicular sensor 110 with respect to the vehicle body 50 by relocating the vehicular sensor 110 close to the occluded side. According to this adjustment need, the control unit 130 would issue corresponding control signals, and the posture-adjusting mechanism 120 would follow the control signals from the control unit 13 to adjust the position of the vehicular sensor 110 with respect to the vehicle body 50 by shifting aside to approach the occluded side. Thereupon, when a side view in front of the vehicle body 50 is occluded by an obstacle 40, and if the instant vehicle speed of the vehicle body 50 is too fast, then the vehicular sensor 110 shall focus at a detected region close to the obstacle 40, and thus the position of the vehicular sensor 110 with respect to the vehicle body 50 would be relocated to approach the first side S1 so as to follow the obstacle 40. By having FIG. 9A as an example, the vehicular sensor 110 should be shifted to the left of the vehicle body 50.

On the other hand, if the determination of Step S325 is positive, then the vehicle speed of the vehicle body 50 is lower than the minimum speed limit of the preset speed range. Namely, the instant vehicle speed of the vehicle body 50 is slower. At this time, an adjustment need can be to adjust the position of the vehicular sensor 110 with respect to the vehicle body 50 by moving away from the occluded side. According to this adjustment need, the control unit 130 would issue corresponding control signals, and the posture-adjusting mechanism 120 would evaluate the control signals from the control unit 130 to adjust the position of the vehicular sensor 110 with respect to the vehicle body 50 by shifting aside to get away from the occluded side. When the side view in front of the vehicle body 50 is occluded, and if the instant vehicle speed of the vehicle body 50 is slower, then the vehicular sensor 110 shall have a farther detected region, or needn't follow the obstacle 40, and thus the position of the vehicular sensor 110 with respect to the vehicle body 50 would be relocated aside to be away from the second side S2 so as to prevent from following the obstacle 40. By having FIG. 9C as an example, the vehicular sensor 110 should be shifted to the right of the vehicle body 50. Thereupon, the vehicular sensor 110 can capture information in front of the obstacle 40. It shall be explained that, in FIG. 9C, the coverage of the detection range DR is only illustrated for example, not for limiting the scope of this disclosure.

In one embodiment not shown here, the event of lateral adjustment E5 and the event of vehicle overtaking E6 of FIG. 5 can be integrated as the environmental scenarios for determining whether or not an adjustment need is necessary. Referring now to FIG. 1, FIG. 8 and FIG. 9A, firstly, it is determined whether or not to overtake other vehicles. If the control unit 130 determines to overtake other vehicles, then the adjustment need would be to adjust the facing angle of the vehicular sensor 110 with respect to the vehicle body 50 by facing a side, a vehicle or an obstacle to be overtaken. According to this adjustment need, the control unit 130 would issue corresponding control signals, and the posture-adjusting mechanism 120 would evaluate the control signals from the control unit 130 to adjust the facing angle of the vehicular sensor 110 with respect to the vehicle body 50 by turning to face the vehicle or obstacle to be overtaken. By having FIG. 9B as an example, if the vehicle body 50 is to overtake the obstacle 40 from the right side of the obstacle 40, then the facing angle of the vehicular sensor 110 with respect to the vehicle body 50 is adjusted to the left for covering the obstacle 40. On the other hand, if the control unit 130 determines not to overtake other vehicles, then the adjustment need would be to evaluate the event of lateral adjustment to adjust the posture P of the vehicular sensor 110. In particular, the determination method shown in FIG. 8 can be used to adjust the posture P of the vehicular sensor 110. This disclosure is not limited to the aforesaid embodiments. Now, the method of adjusting the position of the vehicular sensor 110 with respect to the vehicle body 50 can be used as the adjustment need for resolving the event of vehicle overtaking E6 (as the environmental scenario ES) of the vehicle body 50. For example, in the case that the vehicle body 50 is to overtake the obstacle 40 from the right side, then the position of the vehicular sensor 110 with respect to the vehicle body 50 is shifted to the left, so that the obstacle 40 can be covered. In the other hand, if the control unit 130 determines not to overtake other vehicles, then the adjustment need would be to evaluate the event of lateral adjustment to adjust the posture P of the vehicular sensor 110. For example, the determination method of FIG. 8 can be used to adjust the posture P of the vehicular sensor 110.

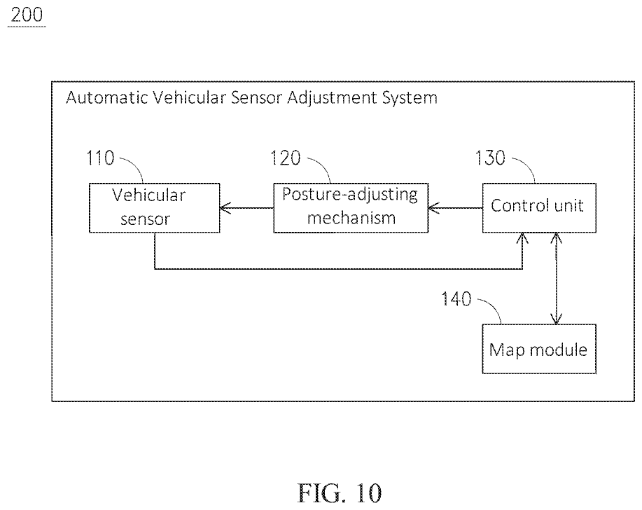

FIG. 10 is a schematic view of another embodiment of the automatic vehicular sensor adjustment system in accordance with this disclosure. It shall be explained that the automatic vehicular sensor adjustment system 200 of FIG. 10 is largely resembled to the automatic vehicular sensor adjustment system 100 of FIG. 1, in which the same elements would be assigned by the same numbers, and details thereabout would be omitted herein. The automatic vehicular sensor adjustment system 200 of FIG. 10 further includes a map module 140 connected with the control unit 130. The map module 140 is used to provide map information to the control unit 130, in which the map information includes a point-cloud map formed by accumulating a plurality of point clouds. Each of the point clouds has at least information of a geometric position (3D coordinate for example), coloring or reflective strength of the target object. Thus, information of environmental heights, road slopes, obstacles, intersections and the like environmental scenario can be captured from the point-cloud map. In addition, the control unit 130 can compare and evaluate signals from the map module 140 and the vehicular sensor 110, so that the vehicle speed of the vehicle body 50 can be obtained. For example, the control unit 130 can evaluate and compare the detected point clouds by the vehicular sensor 110 (such as an LiDAR) and the point clouds in the point-cloud map of the map module 140, so that an instant position of the vehicle body 50 in the point-cloud map can be obtained. Thus, by evaluating positions at different times, the instant vehicle speed of the vehicle body 50 can be estimated.

Referring back to Step S120 of FIG. 4, by further integrating the map module 140, the environmental scenario of the vehicle body 50 can be estimated according to the map information. By providing the environmental scenario of the map information to the control unit 130, the control unit 130 can integrate the map information to determine whether or not and adjustment need is necessary to adjust the posture of the vehicular sensor 110, in which the control unit 130 can include hardware (such as processors or mainframe computers), software (such as program commands performed by a processor), or a combination of hardware and software. Thus, in this embodiment, the control unit 130 can integrate the map information of the map module 140 to obtain environmental heights, road slopes, obstacles, intersections and the like environmental scenario. According to the adjustment need, the control unit 130 would adjust the vehicular sensor 110 and output corresponding control signals, and the posture-adjusting mechanism 120 would evaluate the control signals from the control unit 130 to adjust the posture of the vehicular sensor 110. Further, as shown in FIG. 5, the environmental scenarios ES can include single event and/or multiple events such as an event of environmental height E1, an event of vehicle speed E2, an event of front occlusion E3, an event of terrain change E4, an event of lateral adjustment E5 and an event of vehicle overtaking E6. The control unit 130 can include an algorithm for evaluating the event of environmental height E1, the event of vehicle speed E2, the event of front occlusion E3, the event of terrain change E4, the event of lateral adjustment E5, the event of vehicle overtaking E6 and combined events, such that the control unit 130 can determine an order of the aforesaid events while in performing the adjustment need. For example, the automatic vehicular sensor adjustment method, as shown in FIG. 6A to FIG. 7C, is to perform the adjustment needs by an order of the event of environmental height E1, the event of front occlusion E3, the event of vehicle speed E2, and the event of terrain change E4.

In addition, after the posture of the vehicular sensor 110 has been adjusted in Step S130, the relationship between the vehicular sensor 110 and the vehicle body 50 shall be calibrated. For example, according to the control signals from the control unit 130, the posture-adjusting mechanism 120 of FIG. 3A would utilize the actuator units 128 to adjust the relationship between the vehicular sensor 110 and the vehicle body 50. The control unit 130 judges the operations or movements of the actuator units 128 to realize the resulted posture of the posture-adjusting mechanism 120, and thereby the coordinate system for the vehicular sensor 110 can undergo dynamic transformation. In other words, this embodiment can utilize the forward-inverse kinematic state of the posture-adjusting mechanism 120 to derive the instant posture of the vehicular sensor 110.

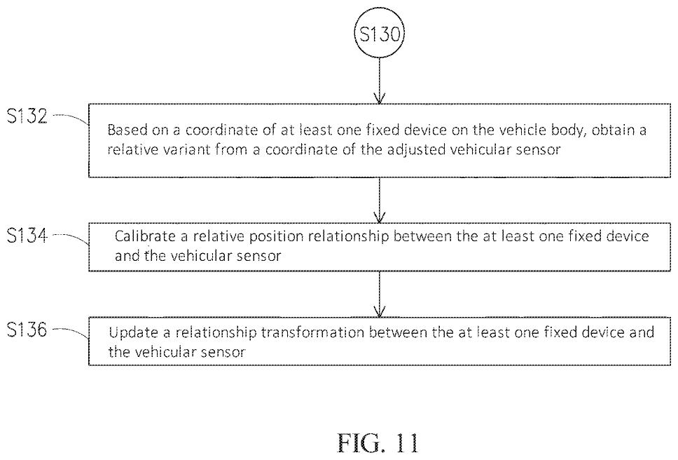

As described above, the forward-inverse kinematic state of the posture-adjusting mechanism 120 can be utilized to calibrate the vehicular sensor 110. On the other hand, referring now to FIG. 11, a flowchart of an extended embodiment of the automatic vehicular sensor adjustment method of FIG. 4 is shown. In performing Step S132, based on a coordinate of at least one fixed device on the vehicle body 50, a relative variant can be derived from a coordinate of the adjusted vehicular sensor 110. For example, the fixed device can be a fixed detector, the fixed detector can be a LiDAR fixed at a specific position at the vehicle body 50 of FIG. 2 (the vehicle roof 52 for example), and then the posture of the fixed detector is not adjustable. That is, a relative coordinate relationship exists between the fixed detector and the vehicle body 50. Thus, according the coordinate of the fixed detector, a relative variant for the coordinate of the adjusted vehicular sensor 110 can be derived. In other words, by having the coordinate of the fixed detector as a reference coordinate, the relative variant for the adjusted vehicular sensor 110 can be obtained. For example, the vehicular sensor 110 has a coordinate, the height of the vehicular sensor 110 with respect to the vehicle body 50 is a first height, and the height of the fixed detector with respect to the vehicle body 50 is also the first height. If the height of the vehicular sensor 110 with respect to the vehicle body 50 is adjusted to be a second height, and the second height is larger than the first height. That is, the vehicular sensor 110 is higher than the fixed detector. Thus, in Step S132, a relative variant can be obtained from the coordinate of the adjusted vehicular sensor 110 by the difference in height between the vehicular sensor 110 and the fixed detector.

Then, in performing Step S134, the relative position relationship between the at least one fixed device and the vehicular sensor 110 can be calibrated. Then, in performing Step S136, the relationship transformation between the at least one fixed device and the vehicular sensor 110 can be updated. In the aforesaid Step S132 to Step S136, the coordinate of the vehicular sensor 110 can undergo dynamic transformation. Thereupon, other fixed device can be also utilized to calibrate the posture of the adjusted vehicular sensor 110. In another embodiment, the fixed detector can be integrated with the map module 140 so as to obtain corresponding map information. By having the map information of the fixed detector as a reference, the control unit 130 can evaluate the map information of the adjusted vehicular sensor 110 so as to dynamically calibrate the relative position relationship between the fixed detector and the vehicular sensor 110.

In summary, in the automatic vehicular sensor adjustment method and the system thereof provided by this disclosure, according to different adjustment needs for different environmental scenarios, the posture of the vehicular sensor can be properly adjusted to provide a preferred detection coverage upon target objects, and also the detected region can be prevented from being occluded by the vehicle body and/or obstacles.

In addition, the automatic vehicular sensor adjustment method and the system thereof provided by this disclosure can further integrate environmental scenarios provided in the map information of the map module to determine and further adjust the posture of the vehicular sensor.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. An automatic vehicular sensor adjustment method, comprising the steps of:
(a) installing a vehicular sensor with a posture on a vehicle body, the posture being defined by at least one of a distance, an inclination and a facing angle of the vehicular sensor with respect to the vehicle body, the distance including a height and a position of the vehicular sensor with respect to the vehicle body;
(b) according to an environmental scenario in which the vehicle body encounters, determining whether or not there is an adjustment need, the environmental scenario including a single event or multiple events; and
(c) according to the adjustment need, adjusting the posture of the vehicular sensor.

2. The automatic vehicular sensor adjustment method of claim 1, wherein the environmental scenario includes an event related to an environmental height, and the step (b) includes the steps of:
(b11) determining whether or not the posture of the vehicular sensor exceeds an environmental height limit; and
(b12) if the posture of the vehicular sensor exceeds the environmental height limit, the adjustment need is to lower the height of the vehicular sensor with respect to the vehicle body.

3. The automatic vehicular sensor adjustment method of claim 1, wherein the environmental scenario includes an event related to a vehicle speed, and the step (b) includes the steps of:
(b21) determining whether or not the vehicle speed of the vehicle body exceeds a preset speed range;
(b22) if the vehicle speed of the vehicle body exceeds the preset speed range, further determining whether or not the vehicle speed of the vehicle body is higher than a maximum speed limit of the preset speed range;
(b23) if the vehicle speed of the vehicle body is higher than the maximum speed limit of the preset speed range, the adjustment need is to raise the height of the vehicular sensor with respect to the vehicle body; and
(b24) if the vehicle speed of the vehicle body is not higher than the maximum speed limit of the preset speed range, further determining whether or not the vehicle speed of the vehicle body is lower than a minimum speed limit of the preset speed range; if the vehicle speed of the vehicle body is lower than the minimum speed limit of the preset speed range, the adjustment need is to lower the height of the vehicular sensor with respect to the vehicle body.

4. The automatic vehicular sensor adjustment method of claim 1, wherein the environmental scenario includes an event related to an occlusion in front, and the step (b) includes the steps of:
(b31) determining whether or not the occlusion in front of the vehicle body exists;
(b32) if the occlusion in front of the vehicle body exist, determining whether or not the vehicle speed of the vehicle body is higher than a maximum speed limit of a preset speed range;
(b33) if the vehicle speed of the vehicle body is higher than the maximum speed limit of the preset speed range, the adjustment need is to lower the height of the vehicular sensor with respect to the vehicle body; and
(b34) if the vehicle speed of the vehicle body is not higher than the maximum speed limit of the preset speed range, determining further whether or not the vehicle speed of the vehicle body is lower than a minimum speed limit of the preset speed range; if the vehicle speed of the vehicle body is lower than the minimum speed limit of the preset speed range, the adjustment need is to raise the height of the vehicular sensor with respect to the vehicle body.

5. The automatic vehicular sensor adjustment method of claim 1, wherein the environmental scenario includes an event related to an occlusion in front, and the step (b) includes the steps of:
(b31) determining whether or not the occlusion in front of the vehicle body exists; and
(b35) if the occlusion in front of the vehicle body exists, the adjustment need is to adjust the height of the vehicular sensor with respect to the vehicle body.

6. The automatic vehicular sensor adjustment method of claim 1, wherein the environmental scenario includes an event related to a vehicle speed, and the step (b) includes the steps of:
(b21) determining whether or not the vehicle speed of the vehicle body exceeds a preset speed range;
(b22) if the vehicle speed of the vehicle body exceeds the preset speed range, further determining whether or not the vehicle speed of the vehicle body is higher than a maximum speed limit of the preset speed range;
(b25) if the vehicle speed of the vehicle body is higher than the maximum speed limit of the preset speed range, the adjustment need is to increase the inclination of the vehicular sensor with respect to the vehicle body; and
(b26) if the vehicle speed of the vehicle body is not higher than the maximum speed limit of the preset speed range, further determining whether or not the vehicle speed of the vehicle body is lower than a minimum speed limit of the preset speed range; if the vehicle speed of the vehicle body is lower than the minimum speed limit of the preset speed range, the adjustment need is to reduce the inclination of the vehicular sensor with respect to the vehicle body.

7. The automatic vehicular sensor adjustment method of claim 1, wherein the environmental scenario includes an event related to an occlusion in front, and the step (b) includes the steps of:
(b31) determining whether or not the occlusion in front of the vehicle body exists;
(b32) if the occlusion in front of the vehicle body exists, determining whether or not the vehicle speed of the vehicle body is higher than a maximum speed limit of a preset speed range;
(b35) if the vehicle speed of the vehicle body is higher than the maximum speed limit of the preset speed range, the adjustment need is to reduce the inclination of the vehicular sensor with respect to the vehicle body; and
(b36) if the vehicle speed of the vehicle body is not higher than the maximum speed limit of the preset speed range, determining further whether or not the vehicle speed of the vehicle body is lower than a minimum speed limit of the preset speed range; if the vehicle speed of the vehicle body is lower than the minimum speed limit of the preset speed range, the adjustment need is to increase the inclination of the vehicular sensor with respect to the vehicle body.

8. The automatic vehicular sensor adjustment method of claim 1, wherein the environmental scenario includes an event related to an occlusion in front, and the step (b) includes the steps of:
(b31) determining whether or not the occlusion in front of the vehicle body exists; and
(b37) if the occlusion in front of the vehicle body exists, the adjustment need is to adjust the inclination of the vehicular sensor with respect to the vehicle body.

9. The automatic vehicular sensor adjustment method of claim 1, wherein the environmental scenario includes an event related to a terrain change, and the step (b) includes the steps of:
(b41) determining whether or not a terrain in front of the vehicle body changes; and
(b42) if the terrain in front of the vehicle body changes, adjusting the posture of the vehicular sensor according to the event related to the terrain change.

10. The automatic vehicular sensor adjustment method of claim 9, wherein the step (b42) includes the steps of:
(b421) determining whether or not a road slope changes;
(b422) if the road slope changes, determining whether the road slope is positive or negative;
(b423) if the road slope is positive, the adjustment need is to lower the height of the vehicular sensor with respect to the vehicle body; and
(b424) if the road slope is negative, the adjustment need is to raise the height of the vehicular sensor with respect to the vehicle body.

11. The automatic vehicular sensor adjustment method of claim 9, wherein the step (b42) includes the steps of:
(b421) determining whether or not a road slope changes;
(b422) if the road slope changes, determining whether the road slope is positive or negative;
(b425) if the road slope is positive, the adjustment need is to reduce the inclination of the vehicular sensor with respect to the vehicle body; and
(b426) if the road slope is negative, the adjustment need is to increase the inclination of the vehicular sensor with respect to the vehicle body.

12. The automatic vehicular sensor adjustment method of claim 9, wherein the step (b42) includes the steps of:
(b427) determining whether an intersection or a winding road exists in front of the vehicle body; and
(b428) if the intersection or the winding road exists in front of the vehicle body, the adjustment need is to raise the height of the vehicular sensor with respect to the vehicle body.

13. The automatic vehicular sensor adjustment method of claim 9, wherein the step (b42) includes the steps of:
(b427) determining whether an intersection or a winding road exists in front of the vehicle body; and
(b429) if the intersection or the winding road exists in front of the vehicle body, the adjustment need is to increase the inclination of the vehicular sensor with respect to the vehicle body.

14. The automatic vehicular sensor adjustment method of claim 1, wherein the environmental scenario includes an event related to a lateral adjustment, and the step (b) includes the steps of:
(b51) determining whether or not a side view in front of the vehicle body is occluded;
(b52) if the side view in front of the vehicle body is occluded, determining whether or not the vehicle speed of the vehicle body is higher than a maximum speed limit of a preset speed range;
(b53) if the vehicle speed of the vehicle body is higher than the maximum speed limit of the preset speed range, the adjustment need is to turn the facing angle of the vehicular sensor with respect to the vehicle body to face an occluded side; and
(b54) if the vehicle speed of the vehicle body is not higher than the maximum speed limit of the preset speed range, determining further whether or not the vehicle speed of the vehicle body is lower than a minimum speed limit of the preset speed range; if the vehicle speed of the vehicle body is lower than the minimum speed limit of the preset speed range, the adjustment need is to turn the facing angle of the vehicular sensor with respect to the vehicle body to be away from the occluded side.

15. The automatic vehicular sensor adjustment method of claim 14, wherein the environmental scenario further includes an event related to a vehicle overtaking, and the step (b) includes the steps of:
(b61) determining whether or not to overtake other vehicles;
(b62) if it is determined to overtake other vehicles, the adjustment need being to turn the facing angle of the vehicular sensor with respect to the vehicle body to face a overtaking side; and
(b63) if it is determined not to overtake other vehicles, the adjustment need being to adjust the posture of the vehicular sensor according to the event related to the lateral adjustment.

16. The automatic vehicular sensor adjustment method of claim 1, wherein the environmental scenario includes an event related to a lateral adjustment, and the step (b) includes the steps of:
(b51) determining whether or not a side view in front of the vehicle body is occluded;
(b52) if the side view in front of the vehicle body is occluded, determining whether or not the vehicle speed of the vehicle body is higher than a maximum speed limit of a preset speed range;
(b55) if the vehicle speed of the vehicle body is higher than the maximum speed limit of the preset speed range, the adjustment need being to move a position of the vehicular sensor with respect to the vehicle body toward an occluded side; and
(b56) if the vehicle speed of the vehicle body is not higher than the maximum speed limit of the preset speed range, determining further whether or not the vehicle speed of the vehicle body is lower than a minimum speed limit of the preset speed range; if the vehicle speed of the vehicle body is lower than the minimum speed limit of the preset speed range, the adjustment need being to move the position of the vehicular sensor with respect to the vehicle body away from the occluded side.

17. The automatic vehicular sensor adjustment method of claim 16, wherein the environmental scenario further includes an event related to a vehicle overtaking, and the step (b) includes the steps of:
(b61) determining whether or not to overtake other vehicles;
(b64) if it is determined to overtake other vehicles, the adjustment need being to move the position of the vehicular sensor with respect to the vehicle body toward an overtaking side; and
(b63) if it is determined not to overtake other vehicles, the adjustment need being to adjust the posture of the vehicular sensor according to the event related to the lateral adjustment.

18. The automatic vehicular sensor adjustment method of claim 1, wherein the step (c) further includes a step of integrating a map information to adjust the posture of the vehicular sensor.

19. The automatic vehicular sensor adjustment method of claim 1, wherein the step (c) includes the steps of:
(c1) based on a coordinate of at least one fixed device at the vehicle body, obtaining a relative variant for another coordinate of the adjusted vehicular sensor;
(c2) calibrating a relative position relationship between the at least one fixed device and the vehicular sensor; and
(c3) updating a relationship transformation between the at least one fixed device and the vehicular sensor.

20. An automatic vehicular sensor adjustment system, applicable to a vehicle body, comprising:
a vehicular sensor with a posture, the posture being defined by at least one of a distance, an inclination and a facing angle of the vehicular sensor with respect to the vehicle body, the distance including a height and a position of the vehicular sensor with respect to the vehicle body;
a control unit, connected with the vehicular sensor, evaluating an environmental scenario to determine whether or not there is an adjustment need, determining an automatic vehicular sensor adjustment method according to the adjustment need, outputting control signals, wherein the environmental scenario includes a single event or multiple events, and the automatic vehicular sensor adjustment method is any one of said automatic vehicular sensor adjustment methods of claims 2-19; and
a posture-adjusting mechanism, connected with the vehicular sensor and the control unit, adjusting the posture of the vehicular sensor according to the control signals of the control unit.

21. The automatic vehicular sensor adjustment system of claim 20, further including a map module connected with the control unit, the map module being to provide a map information to the control unit and to estimate the environmental scenario in which the vehicle body encounters according to the map information, the control unit integrating the map information to determine whether or not there is the adjustment need.

22. The automatic vehicular sensor adjustment system of claim 20, wherein the posture-adjusting mechanism includes a linear adjustment mechanism, a rotational adjustment mechanism or a combination of the linear adjustment mechanism and the rotational adjustment mechanism
